(19) United States
(12) Patent Application Publication
(10) Pub. No.: US 2026/0198584 A1
(43) Pub. Date: Jul. 16, 2026

(54) HEATING ASSEMBLY AND AEROSOL GENERATING DEVICE

(71) Applicant: SMOORE INTERNATIONAL HOLDINGS LIMITED, Grand Cayman (KY)

(72) Inventors: Huanxi LI, Shenzhen (CN); Lewen Chen, Shenzhen (CN); Yubin Xian, Shenzhen (CN); Hongming Zhou, Shenzhen (CN)

(73) Assignee: SMOORE INTERNATIONAL HOLDINGS LIMITED, Grand Cayman (KY)

(21) Appl. No.: 19/558,829

(22) Filed: Mar. 6, 2026

Related U.S. Application Data
(63) Continuation of application No. PCT/CN2024/105339, filed on Jul. 12, 2024.

(30) Foreign Application Priority Data
Sep. 8, 2023 (CN) 202311160268.7

(51) Int. Cl. A24F 40/46; A24F 40/51; A24F 40/57

(52) U.S. Cl. CPC A24F 40/46; A24F 40/51; A24F 40/57

(57) ABSTRACT

A heating assembly includes an outer tube, a first electrode, a second electrode, and a temperature measuring assembly. Both the first electrode and the second electrode are at least partially disposed inside the outer tube, the first electrode and the second electrode are disposed opposite to each other at an interval, and plasma is generated between the first electrode and the second electrode when the first electrode and the second electrode are energized. The temperature measuring assembly is connected to the outer tube, and the temperature measuring assembly is configured to detect the temperature of the outer tube.

### RELATED APPLICATIONS

This application is a continuation application of International application No. PCT/CN2024/105339, filed on Jul. 12, 2024, which claims the priority of Chinese Patent Application No. 202311160268.7, filed on Sep. 8, 2023, which is incorporated herein by reference in its entirety.

### TECHNICAL FIELD

This application relates to the technical field of aerosol generating devices, including to a heating assembly and an aerosol generating device.

### BACKGROUND

In the related technology, an aerosol generating device includes an outer tube. The outer tube may be in contact with an aerosol generating substrate. The aerosol generating device can heat the aerosol generating substrate by plasma heating, to enable the aerosol generating substrate to generate an aerosol. In view of this, how to improve a heating effect on the aerosol generating substrate has become a technical problem that is of significant concern.

### SUMMARY

This disclosure provides a heating assembly and an aerosol generating device.

The heating assembly provided in examples of this disclosure includes an outer tube, a first electrode, a second electrode, and a temperature measuring assembly. At least a portion of the first electrode and at least a portion of the second electrode are disposed in the outer tube, the first electrode and the second electrode are disposed opposite to and space apart from each other, and plasma is generated between the first electrode and the second electrode when the first electrode and the second electrode are energized; and the temperature measuring assembly is connected to the outer tube, and the temperature measuring assembly is configured to detect the temperature of the outer tube.

In the heating assembly provided in the examples of this disclosure, the temperature of the outer tube is detected by the temperature measuring assembly. In this way, the heating assembly can adjust, based on the temperature of the outer tube, voltage applied to the first electrode and the second electrode, to control the heating temperature of the heating assembly, thereby improving a heating effect of the heating assembly on an aerosol generating substrate. In addition, the temperature measuring assembly is mounted by a simple and efficient process.

In an aspect, the temperature measuring assembly includes a temperature sensing portion and a conductive portion connected to the temperature sensing portion. The temperature sensing portion is disposed on the outer tube. In an aspect, the temperature sensing portion is disposed on the outer wall or the inner wall of the outer tube.

In an aspect, the temperature sensing portion includes a temperature sensing film attached to the outer tube.

In an aspect, at least a portion of the temperature sensing film is disposed to extend in a circumferential direction of the outer tube.

In an aspect, the temperature sensing film is in a closed ring shape, a ring shape with an opening, or a U shape.

In an aspect, in an axial direction of the outer tube, the width of the temperature sensing film ranges from 0.5 mm to 1.2 mm.

In an aspect, the resistance of the temperature sensing portion is greater than the resistance of the conductive portion.

In an aspect, the first electrode includes a discharge end surface facing the second electrode, and the temperature sensing portion is disposed on the side of the discharge end surface away from the second electrode.

In an aspect, in an axial direction of the outer tube, a distance between the temperature sensing portion and a plane where the discharge end surface is located ranges from 0 mm to 2 mm. In an aspect, a temperature coefficient of the temperature sensing film is greater than or equal to 300 ppm/° C.

In an aspect, the heating assembly includes a protective layer enclosing at least one of the temperature sensing portion and the conductive portion.

In an aspect, the number of conductive portions is two, and the two conductive portions are arranged at an interval in a circumferential direction of the outer tube.

In an aspect, the heating assembly includes an inner tube at least partially disposed inside the outer tube. The first electrode is at least partially disposed inside the inner tube, at least a portion of the second electrode is disposed at one end of the inner tube, and the first electrode and the second electrode are disposed opposite to each other at an interval.

In an aspect, the temperature sensing portion includes a temperature measuring probe or a thermocouple.

The aerosol generating device provided in examples of this disclosure includes the heating assembly according to any one of the foregoing examples.

Additional aspects and advantages of this disclosure will be given in part in the description below, and in part will become apparent from the description below, or will be learned through the practice of this disclosure.

### BRIEF DESCRIPTION OF THE DRAWINGS

The foregoing and/or additional aspects and advantages of this disclosure will become apparent and comprehensible from the description of the examples made with reference to the following drawings.

FIG. 1 is a schematic structural diagram of an aerosol generating device according to an example of this disclosure;

FIG. 2 is a schematic structural diagram of a heating assembly according to an example of this disclosure;

FIG. 3 is a schematic cross-sectional view of a structure of the heating assembly in FIG. 2 in the A-A direction;

FIG. 4 is a schematic structural diagram of a heating assembly according to another example of this disclosure;

FIG. 5 is a schematic structural diagram of a temperature measuring assembly in the heating assembly in FIG. 2;

FIG. 6 is a schematic structural diagram of a temperature measuring assembly in the heating assembly in FIG. 4;

FIG. 7 is a schematic structural diagram of a temperature measuring assembly according to yet another example of this disclosure;

FIG. 8 is a schematic enlarged view of a structure of a portion B in FIG. 3;

FIG. 9 is a schematic structural diagram of a temperature measuring assembly according to yet another example of this disclosure;

FIG. 10 is a schematic diagram of a combination of the temperature measuring assembly in FIG. 9 and a base;

FIG. 11 is a schematic diagram of a partial structure of a heating assembly according to an example of this disclosure;

FIG. 12 is a schematic cross-sectional view of the heating assembly in FIG. 11 in the D-D direction;

FIG. 13 is a schematic diagram of an exploded structure of the heating assembly in FIG. 11 of this disclosure;

FIG. 14 is a schematic cross-sectional view of the heating assembly in FIG. 11 in the B-B direction;

FIG. 15 is a schematic diagram of a partial structure of a heating assembly according to an example of this disclosure;

FIG. 16 is a schematic structural diagram of a conductive member according to an example of this disclosure;

FIG. 17 is a schematic structural diagram of a conductive member according to another example of this disclosure;

FIG. 18 is a schematic structural diagram of a conductive member according to yet another example of this disclosure;

FIG. 19 is a schematic structural diagram of a conductive member according to yet another example of this disclosure;

FIG. 20 is a schematic cross-sectional view of the heating assembly in FIG. 18 in the C-C direction;

FIG. 21 is a schematic partial enlarged view of a portion D in FIG. 20;

FIG. 22 is a schematic structural diagram of a conductive member according to yet another example of this disclosure;

FIG. 23 is a schematic cross-sectional view of the heating assembly in FIG. 16 in the E-E direction;

FIG. 24 is a schematic structural diagram of a heating assembly according to yet another example of this disclosure;

FIG. 25 is a schematic diagram of a partial heating assembly according to another example of this disclosure;

FIG. 26 is a schematic cross-sectional view of the heating assembly in FIG. 25 in the F-F direction;

FIG. 27 is a schematic enlarged view of a partial cross-section of the heating assembly in FIG. 26;

FIG. 28 is a schematic partial enlarged view of a portion G in FIG. 26;

FIG. 29 is a schematic structural diagram of a heating assembly according to yet another example of this disclosure;

FIG. 30 is a schematic cross-sectional view of the heating assembly in FIG. 29 in the H-H direction; and

FIG. 31 is a schematic diagram of an exploded structure of the heating assembly in FIG. 29.

### DESCRIPTION OF REFERENCE NUMERALS

1000: aerosol generating device; 200: power supply; 210: battery; 220: transformer; 300: aerosol generating substrate; 400: control center; and 500: cover;
100: heating assembly; 10: inner tube; 1001: outer circumferential surface; 101: first tube segment; 102: second tube segment; 11: first end surface; 12: second end surface; 1011: central axis; 20: outer tube; 21: tapered end portion; 22: open end; 230: opening; 110: first electrode; 1104: discharge end surface; 111: discharge end; 112: conductive end; 113: lead; 120: second electrode; 121: mounting portion; 122: protrusion; 130: discharge region; 30: conductive member; 31: first end portion; 32: second end portion; 301: first conductive portion; 302: second conductive portion; 33: connecting wire; 330: conductive wire; 34: conductive strip; 341: first conductive strip; 342: second conductive strip; 310: first conductive ring; 320: second conductive ring; 35: hollowed-out portion; 351: first hollowed-out portion; 352: second hollowed-out portion; 40: insulating member; 41: first insulating portion; 42: second insulating portion; 421: through hole; 50: connector; 60: infrared radiation film; 1002: heat insulating gap; 70: elastic member; 80: temperature measuring assembly; 81: temperature sensing portion; 82: conductive portion; 83: temperature measuring lead; 84: temperature sensing film; 85: protective layer; 90: base; 91: first bracket; 92: second bracket; 93: housing; and 903: wire outlet hole.

### DETAILED DESCRIPTION

The examples of this disclosure are described in detail below, and examples of the examples are shown in the accompanying drawings, where the same or similar reference numerals throughout represent the same or similar elements or elements having the same or similar functions. The examples described below with reference to the accompanying drawings are exemplary and are only used to explain this disclosure, and cannot be understood as limiting this disclosure.

In the description of this disclosure, it should be understood that the terms “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “counterclockwise”, and the like indicate positions or positional relationships based on the positions or positional relationships shown in the accompanying drawings, and are only for the convenience of describing this disclosure and simplifying the description, rather than indicating or implying that the device or element referred to needs to have a specific orientation, be constructed and operated in a specific orientation, and therefore cannot be understood as a limitation to this disclosure. In addition, the terms “first” and “second” are only used for descriptive purposes, and cannot be understood as indicating or implying relative importance or implicitly indicating the number of technical features indicated. Therefore, the features defined as “first” and “second” may explicitly or implicitly include one or more of the features. In the description of this disclosure, “a plurality of” means two or more, unless otherwise clearly and specifically defined.

In the description of this disclosure, it should be noted that, unless otherwise clearly specified and defined, the terms “install”, “connect”, and “link” should be understood in a broad sense, for example, it may be a fixed connection, a detachable connection, or an integral connection; it may be a mechanical connection, an electrical connection, or mutual communication; it may be a direct connection or an indirect connection through an intermediate medium; or it may be internal communication between two elements or the interaction relationship between two elements. Those of ordinary skill in the art may understand the specific meanings of the foregoing terms in this disclosure according to specific circumstances.

In this disclosure, unless otherwise clearly specified and defined, a first feature being “above” or “below” a second feature may include that the first and second features are in direct contact, or may include that the first and second features are not in direct contact but are in contact through another feature between them. Furthermore, the first feature being “over”, “above”, or “on” the second feature includes that the first feature is directly or obliquely above the second feature, or merely indicates that the first feature is higher in level than the second feature. The first feature being “below”, “under”, or “beneath” the second feature includes that the first feature is directly or obliquely below the second feature, or merely indicates that the first feature is lower in level than the second feature.

The following disclosure provides many different examples for implementing different structures of this disclosure. To simplify the disclosure of this disclosure, the parts and configurations of specific examples are described below. Of course, they are only examples and are not intended to limit this disclosure. In addition, reference numerals and/or reference letters may be repeated across different examples in this disclosure. Such repetition is for the purpose of simplicity and clarity and does not in itself indicate any relationship between the various examples and/or configurations discussed. In addition, examples of various specific processes and materials are provided in this disclosure, but those of ordinary skill in the art may recognize the disclosure of other processes and/or the use of other materials.

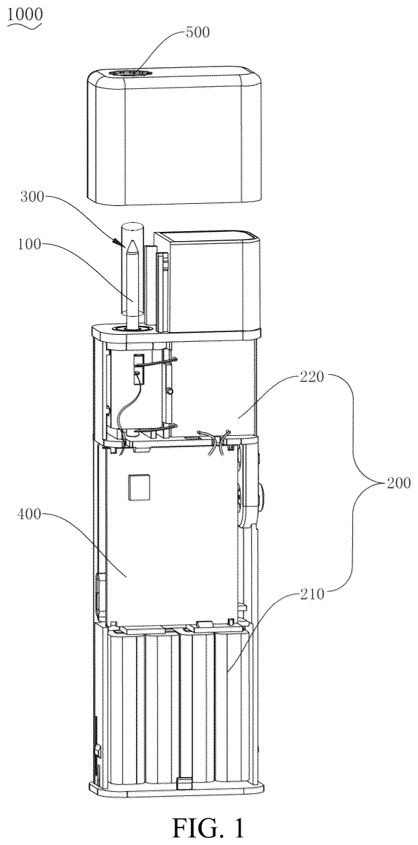

Refer to FIG. 1. This disclosure provides a heating assembly 100 and an aerosol generating device 1000. The heating assembly 100 is configured to heat an aerosol generating substrate 300 through plasma to generate an aerosol in the aerosol generating device 1000. The aerosol generated in the aerosol generating device 1000 can be used for various purposes such as food, medicine, and industrial production.

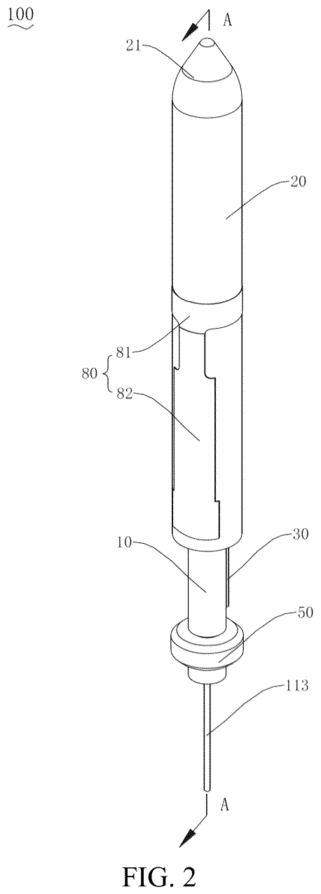

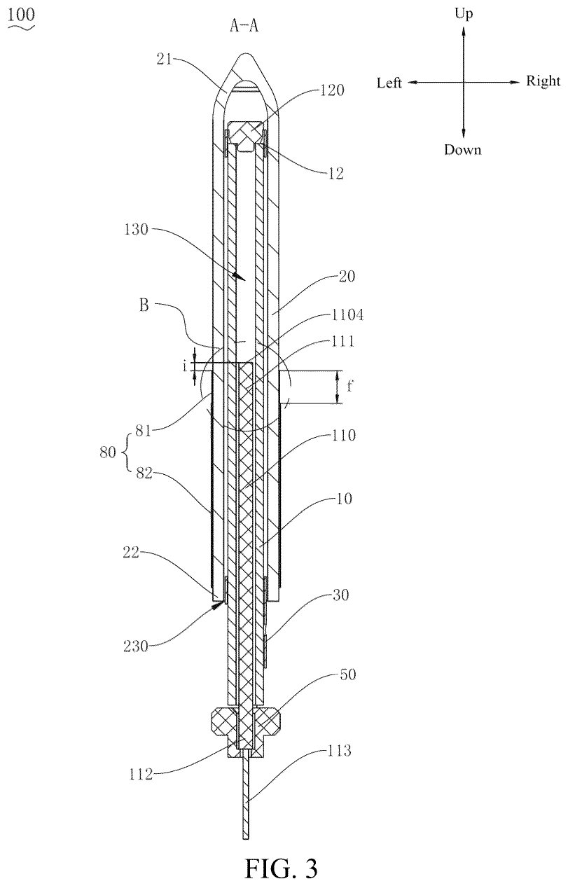

Refer to FIG. 2 and FIG. 3. The heating assembly 100 provided in examples of this disclosure includes an outer tube 20, a first electrode 110, a second electrode 120, and a temperature measuring assembly 80. Both the first electrode 110 and the second electrode 120 are at least partially disposed in the outer tube 20, the first electrode 110 and the second electrode 120 are at least partially disposed opposite to and space apart from each other, and plasma is generated between the first electrode 110 and the second electrode 120 when the first electrode 110 and the second electrode 120 are energized; and the temperature measuring assembly 80 is connected to the outer tube 20, and the temperature measuring assembly 80 is configured to detect the temperature of the outer tube 20.

In the heating assembly 100 provided in the examples of this disclosure, the temperature of the outer tube 20 is detected by the temperature measuring assembly 80. In this way, the heating assembly 100 can adjust voltage applied to the first electrode 110 and the second electrode 120 based on the temperature of the outer tube 20, to control the heating temperature of the heating assembly 100, thereby improving a heating effect of the heating assembly 100 on the aerosol generating substrate 300.

Plasma is a form of matter that contains a large number of charged particles and neutral atoms and molecules, and maintains electrical neutrality as a whole. Under the action of an electric field, the plasma can be generated through gas ionization. A large amount of heat can be generated during generation of the plasma, the maximum temperature of the plasma generated between the first electrode 110 and the second electrode 120 can reach 2000° C., and the temperature ranges from 1000° C. to 1600° C. under stable conditions. Therefore, the heating assembly 100 may utilize the heat generated during generation of the plasma and the high temperature of the plasma to heat the aerosol generating substrate 300, so as to generate the aerosol.

Specifically, the outer tube 20 is a hollow tube body that is disposed to cover the first electrode 110 and the second electrode 120. The first electrode 110 and the second electrode 120 are arranged opposite to each other inside the outer tube 20 and are spaced apart by a predetermined distance. A region where the first electrode 110 and the second electrode 120 are opposite to and spaced apart from each other may be defined as a discharge region 130. Plasma is generated through discharge between the first electrode 110 and the second electrode 120 within the discharge region 130. The inner wall of the outer tube 20 encloses the discharge region 130, and the outer wall of the outer tube 20 may be in direct contact with the aerosol generating substrate 300.

With reference to FIG. 1, the outer tube 20 may be partially inserted into the aerosol generating substrate 300 in an axial direction of the outer tube. The end of the outer tube 20 that is inserted into the aerosol generating substrate 300 may be closed and protrude outward to form a sharp tapered end portion 21. The end of the outer tube 20 opposite to the tapered end portion 21 in the axial direction has an opening 230, and the end of the outer tube 20 that has the opening 230 is an open end 22.

The first electrode 110 and the second electrode 120 may extend into the outer tube 20 from the opening 230, at least a portion of the second electrode 120 extends into the tapered end portion 21, and the portion of the first electrode 110 that extends into the outer tube 20 is farther away from the tapered end portion 21 compared to the second electrode 120. The first electrode 110 may be in a cylindrical shape and is approximately coaxial with the outer tube 20. One end portion of the first electrode 110 in the axial direction of the outer tube 20 is opposite to at least a portion of the second electrode 120, and is a discharge end 111. The other end of the first electrode 110 in the axial direction of the outer tube 20 may be a conductive end 112 that may be partially exposed outside the outer tube 20 from the opening 230.

It should be noted that the first electrode 110 and the second electrode 120 may be connected to direct current, or may be connected to alternating current. In a case that direct current is applied to the first electrode 110 and the second electrode 120, the first electrode 110 and the second electrode 120 generate plasma by means of the direct current; or in a case that alternating current is applied to the first electrode 110 and the second electrode 120, the first electrode 110 and the second electrode 120 generate plasma by means of the alternating current.

The outer tube 20 may transfer the heat from the discharge region 130 to the aerosol generating substrate 300 in a heat transfer manner such as infrared radiation. The temperature of the outer tube 20 increases under the influence of the high temperature of the plasma in the discharge region 130. For different types of aerosol generating substrates 300, when the temperature of the outer tube 20 is stabilized at 200° C. and 350° C., a good heating and atomization effect can be achieved. If the temperature of the outer tube 20 exceeds 350° C. for a long time, the aerosol generating substrate 300 is prone to charring and carbonization.

The temperature measuring assembly 80 is connected to the outer tube 20, and can detect temperature data of the outer tube 20 in real time. With reference to FIG. 1, in some embodiments, the temperature measuring assembly 80 is connected to a control center 400, and the temperature measuring assembly 80 transmits detected temperature data of the outer tube 20 to the control center 400. When the temperature is too high or insufficient, the control center 400 adjusts voltage or output power of a power supply 200 to control voltage between the first electrode 110 and the second electrode 120, thereby adjusting the heating temperature.

Refer to FIG. 2 and FIG. 3. In an aspect, the temperature measuring assembly 80 includes a temperature sensing portion 81 and a conductive portion 82 connected to the temperature sensing portion 81. The temperature sensing portion 81 is disposed on the outer tube 20.

In this way, the temperature sensing portion 81 is connected to a circuit through the conductive portion 82, so that the temperature of the outer tube 20 can be obtained by detecting a resistance value of the temperature sensing portion 81 in the circuit.

Specifically, the temperature sensing portion 81 is a portion of the temperature measuring assembly 80 whose resistance value changes significantly with the temperature of the outer tube 20. The temperature sensing portion 81 may be located between two axial ends of the outer tube 20, and is in direct contact with the outer tube 20. The portion of the outer tube 20 that is in contact with the temperature sensing portion 81 is a target region for the temperature measuring assembly 80 to detect the temperature. The conductive portion 82 may extend from the temperature sensing portion 81 to the open end 22 in the axial direction of the outer tube 20. The conductive portion 82 may be connected to a temperature measuring lead 83 at the open end 22, and is connected to a circuit of the control center 400 through the temperature measuring lead 83. It should be noted that the conductive portion 82 and the temperature sensing portion 81 may be different portions of an integrally formed element, or two different elements in contact connection.

The conductive portion 82 may be used as an electrode that is electrically connected to the temperature sensing portion 81 and the control center 400, to form a conductive circuit. The conductive portion 82 may be in contact connection with the control center 400 through a soldered lead or a conductive spring contact. The control center 400 can calculate a change in the resistance value of the temperature sensing portion 81 by detecting a change in voltage in the circuit, and then calculate the temperature of the detected target region.

A direction pointing from the tapered end portion 21 to the open end 22 in the axial direction of the outer tube 20 is defined as a top-to-bottom direction. A particular interval is maintained between the lower end of the conductive portion 82 and the end surface of the open end 22, and a distance between the lower end of the conductive portion 82 and the end surface of the open end 22 ranges from 0.3 mm to 3 mm.

This can avoid contact conduction between the conductive portion 82 and the high-voltage electrode inside the outer tube 20, thereby avoiding interference with the discharge between the first electrode 110 and the second electrode 120 and ensuring plasma generation.

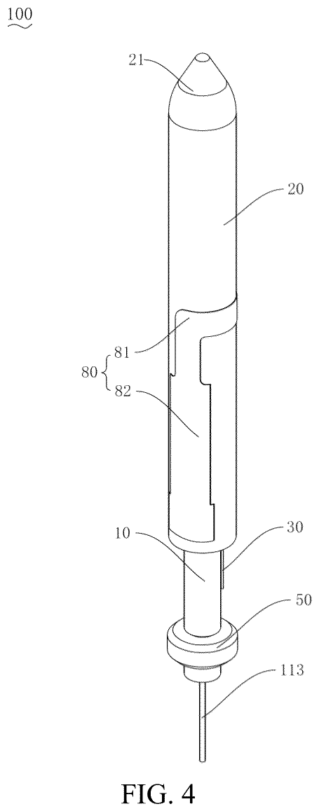

Refer to FIG. 2 and FIG. 4. In an aspect, the temperature sensing portion 81 is disposed on the outer wall or inner wall of the outer tube 20.

In this way, the temperature sensing portion 81 can effectively sense the heating temperature applied by the outer tube 20 to the aerosol generating substrate 300, to achieve more precise temperature control of the heating assembly 100.

Specifically, the temperature sensing portion 81 may be adhered to the outer wall of the outer tube 20 and fixedly disposed relative to the outer tube 20. The portion of the outer tube 20 covered by the temperature sensing portion 81 may be inserted into the aerosol generating substrate 300. Alternatively, the temperature sensing portion 81 may be disposed inside the outer tube 20 and connected to the inner wall surface of the outer tube 20.

The outer tube 20 may be made of an insulating material that is transparent to infrared radiation. For example, the outer tube 20 is made of a material such as quartz, ceramic, or quartz glass.

In some embodiments, the wall thickness of the outer tube 20 ranges from 0.3 mm to 0.5 mm (including the endpoint values). The outer diameter of the outer tube 2020 is denoted as D that preferably satisfies 2.0 mm≤D≤3.0 mm. For example, the wall thickness of the outer tube 20 may be 0.3 mm, 0.35 mm, 0.4 mm, 0.45 mm, or 0.5 mm, and the outer diameter of the outer tube 20 may be 2.0 mm, 2.1 mm, 2.3 mm, 2.6 mm, 2.8 mm, or 3 mm. The outer tube 20 may be selected from a quartz tube with the outer diameter of 2.0 mm and the wall thickness of 0.3 mm. For another example, the outer tube 20 may be a quartz tube with the outer diameter of 3.0 mm and the wall thickness of 0.4 mm.

Refer to FIG. 4 to FIG. 7. In an aspect, the temperature sensing portion 81 includes a temperature sensing film 84 adhered to the outer tube 20.

In this way, the temperature sensing film 84 increases a contact area between the temperature sensing portion 81 and the outer tube 20, so that the resistance value of the temperature sensing portion 81 is more sensitive and accurate with the respect to changes in the temperature of the outer tube 20.

Specifically, the temperature sensing film 84 may be deposited on the outer wall or inner wall surface of the outer tube 20 and form various patterns on the wall surface of the outer tube 20.

For example, the temperature sensing film 84 may be in a circular-ring shape, a straight-strip shape, a sector shape, a wave shape, or the like. The temperature sensing film 84 is in a close fit with the outer wall of the outer tube 20, and the temperature of the outer tube 20 may be transferred to the temperature sensing film 84 in a heat transfer manner. It may be understood that by increasing the contact area between the temperature sensing film 84 and the outer tube 20, the amount of heat absorbed by the temperature sensing film 84 per unit volume from the outer tube 20 is increased, thereby improving the sensitivity of the temperature sensing film 84 to the temperature of the outer tube 20.

The temperature sensing film 84 may be made of a resistive material with conductive properties. For example, the temperature sensing film 84 is made of at least one of platinum, gold, silver, chromium, nickel, and alloys containing platinum, gold, silver, chromium, and nickel.

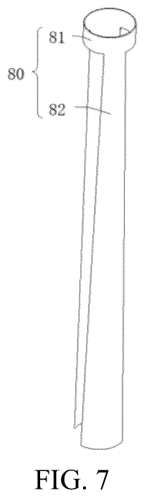

In some embodiments, the conductive portion 82 may be made of the same material as the temperature sensing film 84, and is adhered to the outer wall of the outer tube 20. Film layers of the conductive portion 82 and the temperature sensing portion 81 may be integrally formed by co-deposition, as shown in FIG. 6. Alternatively, the conductive portion 82 may be made of a material different from that of the temperature sensing film 84, may be a separate element, and is in contact connection with the temperature sensing film 84. The conductive portion 82 may be in various shapes or irregular patterns, such as a rectangle, a cone, or a trapezoid. For example, as shown in FIG. 7, the width of the conductive portion 82 in the circumferential direction of the outer tube 20 gradually decreases in a direction toward the temperature sensing portion 81, and the conductive portion 82 is approximately trapezoidal. The width of the end portion of the conductive portion 82 away from the temperature sensing film 84 is appropriately increased, so that the conductive portion 82 is less prone to defects such as curling and cracking at the high temperature. In this way, the connection between the temperature measuring assembly 80 and the outer tube 20 is more stable.

Refer to FIG. 2 and FIG. 4 again. In an aspect, at least a portion of the temperature sensing film 84 is disposed to extend in the circumferential direction of the outer tube 20.

This is beneficial for the temperature sensing film 84 to measure the average circumferential temperature of the outer tube 20, thereby improving the accuracy of temperature measurement.

Specifically, the temperature sensing film 84 may be coated on the outer tube 20 at the distance of 3 mm to 14 mm away from the apex of the tapered end portion 21 in the axial direction of the outer tube, fits the outer circumference of the outer tube 20, and is in close contact with the outer wall of the outer tube 20. The upper end of the conductive portion 82 extends upward in the axial direction of the outer tube 20 to the lower edge of the temperature sensing film 84, and is in contact connection with the temperature sensing film 84. The temperature sensing film 84 extends by 2 mm to 8 mm in the circumferential direction of the outer tube 20. In other words, in the circumferential direction of the outer tube 20, the circumference of the temperature sensing film 84 may range from 2 mm to 8 mm. The outer circumference of the outer tube 20 is greater than or equal to the circumference of the temperature sensing film 84. Two conductive portions 82 may be provided and respectively connected to two ends of the temperature sensing film 84 in the circumferential direction of the outer tube 20. Alternatively, the conductive portion 82 may be connected to the temperature sensing film 84 between two ends of the temperature sensing film 84 in the circumferential direction of the outer tube 20.

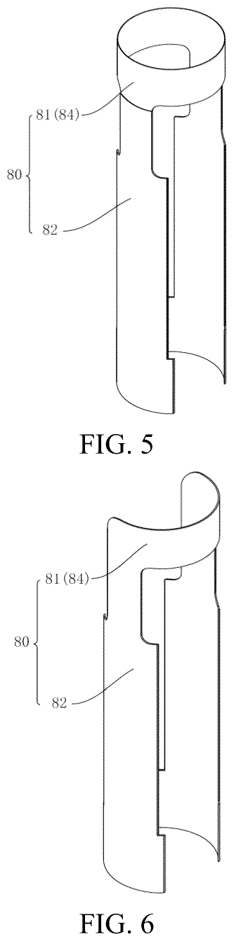

Refer to FIG. 5 and FIG. 6. In an aspect, the temperature sensing film 84 is in a closed ring shape, a ring shape with an opening, or a U shape. In this way, the temperature sensing film 84 is in an annular pattern, and can sensor the average circumferential temperature of the outer tube 20, thereby improving the accuracy of temperature measurement.

In some embodiments, as shown in FIG. 5, the temperature sensing film 84 encircles the circumferential surface of the outer tube 20 to form a shield encircling the circumferential surface of the outer tube 20. The temperature sensing film 84 is in a closed ring shape, and the circumference of the temperature sensing film 84 is equal to the outer circumference of the outer tube 20. Two conductive portions 82 connected to the temperature sensing film 84 are provided. The two conductive portions 82 may be disposed at an interval in the circumferential direction of the outer tube 20 and extend downward in the axial direction of the outer tube 20. In this embodiment, the temperature sensing film 84 may be divided into left and right semi-circles by using connection points between the two conductive portions 82 and the temperature measuring film as boundaries. In the closed temperature measurement circuit formed by the conductive portion 82 and the temperature sensing film 84, the left and right semi-circles of the temperature sensing film 84 that are divided by using the conductive portion 82 as boundaries are connected in parallel.

In some embodiments, as shown in FIG. 6, the temperature sensing film 84 is disposed to encircle the circumferential surface of the outer tube 20 to form a ring with an opening encircling the circumferential surface of the outer tube 20. The ring with an opening may be a semi-circular ring, a two-thirds circular ring, a semi-elliptical ring, or the like. For example, the cross-sectional shape of the temperature sensing film 84 may be U-shaped or substantially U-shaped. The temperature sensing film 84 does not cover the outer tube 20 at the opening of the ring, and the circumference of the temperature sensing film 84 is less than the outer circumference of the outer tube 20. The conductive portion 82 and the temperature sensing film 84 form a single-wire series temperature measurement circuit.

It should be noted that the shape of the temperature sensing film 84 is not limited to a ring in this disclosure. The temperature sensing film 84 may be a circular ring, an elliptic ring, a ring formed by a plurality of arc segments, or the like. Alternatively, the temperature sensing film 84 may be on the outer tube 20 in an irregular pattern that is formed by a combination of a plurality of patterns or shapes such as a strip shape and a square shape.

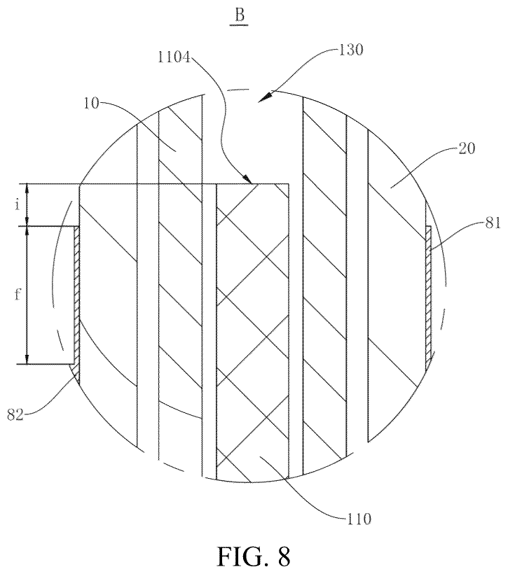

Refer to FIG. 3 and FIG. 8. In an aspect, in the axial direction of the outer tube 20, the width f of the temperature sensing film 84 ranges from 0.5 mm to 1.2 mm (including endpoint values).

By properly setting the width of the temperature sensing film 84, the resistance of the temperature sensing portion 81 and the area of the temperature measurement target region can be adjusted, thereby improving the accuracy of temperature measurement.

Specifically, the width of the temperature sensing film 84 in the axial direction of the outer tube 20 may be uniform. For example, the width f of the temperature sensing film 84 may be 0.5 mm, 0.6 mm, 0.7 mm, 0.85 mm, 1.0 mm, 1.1 mm, or 1.2 mm. Alternatively, in some embodiments, the width of the temperature sensing film 84 in the axial direction of the outer tube 20 may be non-uniform. For example, the width f of the temperature sensing film 84 may range from 0.5 mm to 1.2 mm, from 0.6 mm to 1.0 mm, or from 0.7 mm to 0.9 mm, and varies between two endpoint values of the foregoing width range.

In an aspect, the resistance of the temperature sensing portion 81 is greater than the resistance of the conductive portion 82.

In this way, the proportion of the resistance value of the temperature sensing portion 81 in the entire resistance value of the temperature measuring assembly 80 is increased, so that a temperature change of the temperature sensing portion 81 is more precisely reflected as a resistance change.

Specifically, in the conductive circuit formed by the temperature sensing portion 81 and the conductive portion 82, the resistance value of the temperature sensing portion 81 is greater, and an electromotive force difference of the temperature sensing portion 81 is also greater. As described above, the control center 400 acquires the resistance change of the temperature sensing portion 81 by measuring the voltage. It may be understood that the resistance of the temperature sensing portion 81 is greater than the resistance of the conductive portion 82, which can increase a voltage change across the temperature sensing portion 81, thereby improving the accuracy of temperature measurement. In some embodiments, a ratio of the resistance value of the temperature sensing portion 81 to the resistance value of the conductive portion 82 is greater than or equal to 2.

Based on factors affecting the change in conductor resistance, the resistance of the temperature sensing portion 81 can be made greater than the resistance of the conductive portion 82 by properly configuring materials, the lengths, the widths, and the conductor cross-sectional areas of the temperature sensing portion 81 and the conductive portion 82. Refer to FIG. 8. For example, both the temperature sensing portion 81 and the conductive portion 82 are temperature measuring films, and the thickness of the temperature sensing portion 81 is smaller than that of the conductive portion 82.

Refer to FIG. 3. In an aspect, the first electrode 110 includes a discharge end surface 1104 facing the second electrode 120, and the temperature sensing portion 81 is disposed on the side of the discharge end surface 1104 away from the second electrode 120.

In this way, the temperature of the side of the discharge end surface 1104 away from the second electrode 120 is lower than the temperature of the center of the discharge region 130. This maintains the temperature sensing portion 81 at low temperature while still meeting the measurement requirements for accuracy and time delay, thereby enhancing the heat-resistance reliability of the temperature measuring assembly 80.

Specifically, the discharge end surface 1104 is the position on the first electrode 110 is closest to the second electrode 120, and is opposite to and spaced apart from the second electrode 120 by a predetermined distance. The discharge region 130 is located between the discharge end surface 1104 and the surface of the side of the second electrode 120 that faces the first electrode 110. A direction pointing from the tapered end portion 21 to the open end 22 in the axial direction of the outer tube 20 is defined as a top-to-bottom direction. The second electrode 120 is located above the first electrode 110, and limits the upper boundary of the discharge region 130. The discharge end surface 1104 limits the lower boundary of the discharge region 130.

When high voltage is applied to the first electrode 110 and the second electrode 120, discharge occurs to generate plasma in the discharge region 130, that is, in the region above the discharge end surface 1104. Consequently, the heat is concentrated in the region below the second electrode 120 and above the discharge end surface 1104. The temperature sensing portion 81 is disposed below the discharge end surface 1104, that is, on the side of the discharge end surface 1104 away from the second electrode 120, so that the temperature of the temperature sensing portion 81 is not too high.

Refer to FIG. 8. In an aspect, in the axial direction of the outer tube 20, a distance i between the temperature sensing portion 81 and a plane where the discharge end surface 1104 is located ranges from 0 mm to 2 mm (including the endpoint values).

In this way, the temperature sensing portion 81 is disposed on a tube segment of the outer tube within 2 mm in the axial direction from the discharge end surface 1104, so that the temperature sensing portion 81 exhibits a temperature response substantially synchronized with that of the discharge region 130, with low delay and high accuracy of temperature measurement.

Specifically, the temperature sensing portion 81 is located on the side of the discharge end surface 1104 away from the second electrode 120, and in the axial direction of the outer tube 20, the distance i between the temperature sensing portion 81 and the plane where the discharge end surface 1104 is located is less than or equal to 2 mm. The distance i between the temperature sensing portion 81 and the plane where the discharge end surface 1104 is located may be considered as a distance between the upper edge of the temperature sensing portion 81 and a plane where the apex of the discharge end surface 1104 is located in the axial direction of the outer tube 20. For example, the distance i between the temperature sensing portion 81 and the plane where the discharge end surface 1104 is located may be 0.1 mm, 0.4 mm, 0.65 mm, 0.9 mm, 1.15 mm, 1.3 mm, 1.5 mm, 1.8 mm, or 2 mm.

Alternatively, in some embodiments, the temperature sensing portion 81 may be located on the side of the discharge end surface 1104 that faces the second electrode 120, and the distance between the temperature sensing portion and the plane where the discharge end surface 1104 is located in the axial direction of the outer tube 20 is also less than or equal to 2 mm.

In an aspect, a temperature coefficient of the temperature sensing film 84 is greater than or equal to 300 ppm/° C. In this way, by selecting the temperature sensing film 84 with the large temperature coefficient, the sensitivity and measurement accuracy of the temperature sensing portion 81 can be improved. Specifically, the temperature coefficient of resistance (temperature coefficient of resistance, TCR for short) represents a relative change in a resistance value per degree Celsius of temperature change, expressed in units of ppm/° C. (namely, 10E(−6)/° C.). A temperature coefficient of the temperature sensing film 84 is greater than or equal to 300 ppm/° C., and when a temperature changes by one degree, a change in a resistance value of the temperature sensing film 84 is 300×10⁻⁶. The temperature sensing film 84 has TCR characteristics, which may exhibit a positive correlation between the resistance value and the temperature change, that is, the resistance value of the temperature sensing film 84 increases as the temperature increases, or may exhibit a negative correlation between the resistance value and the temperature change, that is, the resistance value of the temperature sensing film 84 decreases as the temperature increases. When the surface temperature of the outer tube 20 increases or changes, based on the TCR characteristics of the temperature sensing film 84 in the temperature measurement circuit, an electronic element connected to the temperature measurement circuit receives a related signal, which may reflect a detected voltage change across the temperature measurement circuit caused by a change in the resistance value. In this way, the surface temperature of the target region of the outer tube 20 corresponding to the temperature sensing film 84 can be calculated.

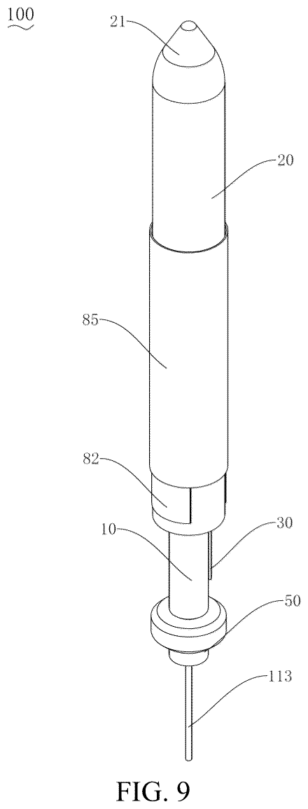

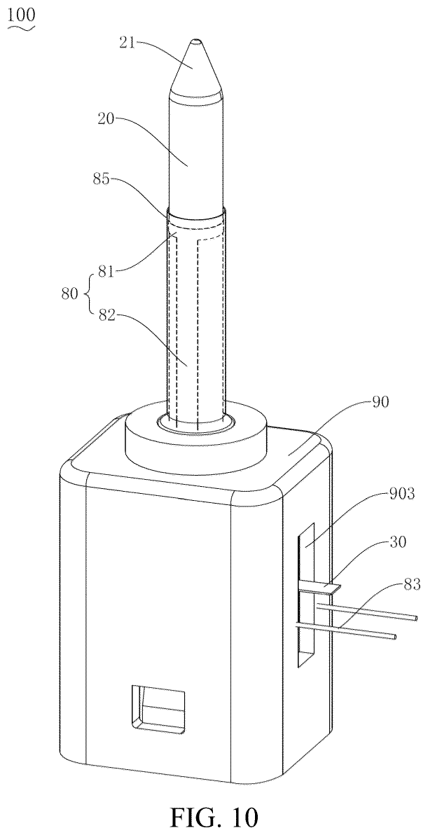

Refer to FIG. 9 and FIG. 10. In an aspect, the heating assembly 100 includes a protective layer 85 enclosing at least one of the temperature sensing portion 81 and the conductive portion 82.

In this way, the protective layer 85 encloses the outer layer of the temperature measuring assembly 80, to reduce wear of the temperature measuring assembly 80 and protect the temperature sensing film 84 in a process in which the temperature measuring assembly 80 is inserted into the aerosol generating substrate 300 together with the outer tube 20.

Specifically, the protective layer 85 may be disposed on the outer surface of the temperature measuring assembly 80 and adhered to the outer wall of the outer tube 20. The protective layer 85 may encircle the tube segment of the outer tube 20 to which the temperature measuring assembly 80 is attached, to form a cylindrical shape that encloses and covers the temperature sensing film 84 and a portion of conductive portion 82. The protective layer 85 may be made of SiO₂ (silicon dioxide) with a low coefficient of expansion and another doped oxide. The weight percentage of SiO₂ may be greater than or equal to 95%. The protective layer 85 may be a glaze layer that is sintered at high temperature by dip coating or screen printing. The thickness of the protective layer 85 may be approximately one third of the wall thickness of the outer tube 20. The glaze layer can increase mechanical strength and thermal stability of the outer tube 20 and the temperature measuring assembly 80. In addition, the glaze layer is electrically insulating, resistant to corrosion by oil fumes, and easy to clean.

Refer to FIG. 5 and FIG. 6. In an aspect, the number of conductive portions 82 is two, and the two conductive portions 82 are arranged at an interval in the circumferential direction of the outer tube 20.

In this way, the temperature sensing film 84 and the conductive portion 82 form a temperature measurement circuit in a particular shape that is distributed in a particular region, which facilitates improvement of the accuracy of representing the temperature of the particular region by the temperature measurement circuit.

Specifically, one conductive portion 82 extends upward from a pin of a lower temperature measuring lead 83 in the axial direction of the outer tube 20 to a position 3 mm to 14 mm away from the apex of the tapered end portion 21, and is connected to the temperature sensing film 84. The temperature sensing film 84 extends in the circumferential direction of the outer tube 20 in a single-line or parallel double-line configuration for a distance of 2 mm to 8 mm, is connected to the other conductive portion 82, and then extends downward in the axial direction the outer tube 20 to a pin of the other temperature measuring lead 83 at the lower end of the outer tube 20. The conductive portion 82 extends downward in the axial direction of the outer tube 20 to a position 0.3 mm to 3 mm away from the end surface of the opening 230. The two conductive portions 82 and the temperature sensing film 84 may form a temperature measurement circuit configured either as a ring-shaped parallel circuit or as a U-shaped single-segment circuit. The two conductive portions 82 are arranged at an interval on the outer circumferential surface of the outer tube 20, and a distance between the two conductive portions 82 in a circumferential direction of the outer tube 20 may range from 2 mm to 8 mm.

Alternatively, in some embodiments, the upper end of the conductive portion 82 may extend above the discharge end surface 1104.

A charged portion of the temperature measuring assembly 80 includes the conductive portion 82 and the temperature sensing film 84, and is far away from the first electrode 110, the second electrode 120, and a conductive element connected to the first electrode 110/the second electrode 120 and the power supply 200 as much as possible, to reduce high-voltage crosstalk. For example, a linear distance between the conductive portion 82 and the temperature measuring lead 83, as well as between the conductive member 30 connected to the second electrode 120 and the connecting wire 33 is greater than 0.5 mm.

The conductive portion 82 may be made of a metal material with high conductivity, and may specifically include one or more of gold, silver, platinum, and copper.

Refer to FIG. 3 again. In an aspect, the heating assembly 100 includes an inner tube 10 at least partially disposed inside the outer tube 20. At least a portion of the first electrode 110 is disposed inside the inner tube 10, at least a portion of the second electrode 120 is disposed at one end of the inner tube 10, and the first electrode 110 and the second electrode 120 are disposed opposite to each other at an interval.

In this way, the inner tube 10 may provide insulation protection for the first electrode 110 and the second electrode 120, and the first electrode 110 and the second electrode 120 may be mounted and limited through the inner tube 10, which facilitates coaxialization and miniaturization of the heating assembly 100. Specifically, the outer tube 20 is sleeved on the inner tube 10. The inner tube 10 is a through tube with openings at both axial ends, and the openings penetrate through the inner tube 10 in the axial direction. The second electrode 120 may be in a disk shape, and interlocks with one end of the inner tube 10, to cover an opening of the end surface. The first electrode 110 may be in a cylindrical shape, and extends into the inner tube 10 from one end of the inner tube 10 away from the second electrode 120, so that a portion of the first electrode 110 is covered by the inner tube 10. The end of the first electrode 110 that extends into the inner tube 10 faces the second electrode 120, and is spaced apart from the second electrode 120 by a particular distance. The discharge region 130 may be a region within the inner tube 10 where the first electrode 110 and the second electrode 120 are opposite to and spaced apart from each other.

The end of the inner tube 10 that is provided with the second electrode 120 may extend into the outer tube 20, so that the second electrode 120 may partially abut against the tapered end portion 21. The end of the inner tube 10 away from the second electrode 120 may extend out of the outer tube 20 from the open end 22, and the first electrode 110 may be exposed outside the inner tube 10 and the outer tube 20 from this end. The end of the first electrode 110 that extends out of the inner tube 10 may be electrically connected to a connector 50. The connector 50 is connected to a lead 113 and is connected to a power supply 200 through the lead 113.

In an aspect, the temperature sensing portion 81 includes a temperature measuring probe or a thermocouple. The temperature measuring probe or the thermocouple may be configured to detect the temperature of the outer tube or the inner tube.

In some embodiments, the thermocouple or the temperature measuring probe of the temperature sensing portion 81 is closely adhered to or disposed close to the outer wall of the outer tube 20.

In some embodiments, the thermocouple or the temperature measuring probe of the temperature sensing portion 81 is disposed between the inner wall of the outer tube 20 and the outer wall of the inner tube 10, and is primarily in contact with the inner wall of the outer tube.

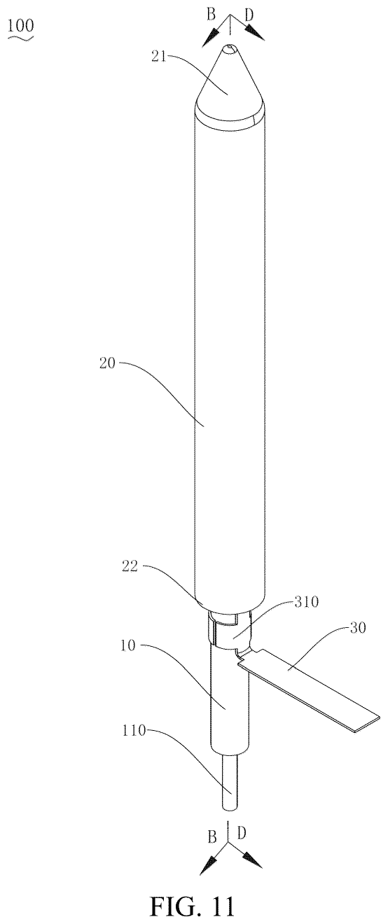

Refer to FIG. 11 to FIG. 13. In an aspect, the heating assembly 100 includes a conductive member 30 connected to the second electrode 120. The conductive member 30 extends in an axial direction of the inner tube 10, and the conductive member 30 is spaced apart from the temperature measuring assembly 80.

In this way, the conductive member 30 can facilitate disclosure of high voltage to the second electrode 120. The conductive member 30 is spaced apart from the temperature measuring assembly 80, which can enhance insulation protection for the temperature measuring assembly 80, to avoid high-voltage crosstalk.

In an aspect, the conductive member 30 is connected to the second electrode 120 and is configured to be electrically connected to the power supply 200. The conductive member 30 extends from one end of the inner tube 10 to the other end of the inner tube 10 in the axial direction of the inner tube 10. In the axial direction of the inner tube 10, the tube segment of the inner tube 10 that corresponds to the conductive member 30 partially faces the outer tube 20.

It should be noted that the tube segment of the inner tube 10 that corresponds to the conductive member 30 may be the portion of the inner tube 10 that is located between the two axial end portions of the conductive member 30, and the axial length of the tube segment of the inner tube 10 that corresponds to the conductive member 30 may be substantially equal to the axial length of the conductive member 30, and the end portions are substantially aligned. In addition, it may be further understood that the conductive member 30 is required for electrical connection between the second electrode 120 and the power supply 200. However, the second electrode 120 and the conductive member 30 are not necessarily two separate parts, and the two may be made of the same material, or may be integrally formed into a whole of which the portion opposite to the first electrode 110 is used as an electrode and the remaining portion is used for electrical connection.

In this disclosure, the description of the second electrode 120 and the conductive member 30 as two separate parts is not intended to limit the two parts as either an integral structure or separate structures, but rather to facilitate better explanation and clarification.

In the heating assembly 100 provided in the examples of this disclosure, the tube segment of the inner tube 10 that corresponds to the conductive member 30 partially faces the outer tube 20, which reduces the volume of the conductive member 30, thereby lowering the heat capacity of the conductive member 30 and reducing the heat stored in the conductive member 30. In addition, a large amount of heat generated by the heating assembly 100 can be directly transferred through the inner tube 10 and the outer tube 20 to the aerosol generating substrate 300, thereby improving the heat utilization and further improving the heating rate and heating efficiency of the aerosol generating substrate 300.

It may be understood that the tube segment of the inner tube 10 that corresponds to the conductive member 30 partially faces the outer tube 20, which means that the partial outer wall surface of the tube segment of the inner tube 10 that corresponds to the conductive member 30 faces the outer tube 20, and the partial outer wall surface faces the outer tube 20 is not shielded by the conductive member 30. Another partial wall surface of the same tube segment of the inner tube 10 faces the outer tube 20, and the partial outer wall surface is shielded by the conductive member 30 and cannot directly face the outer tube.

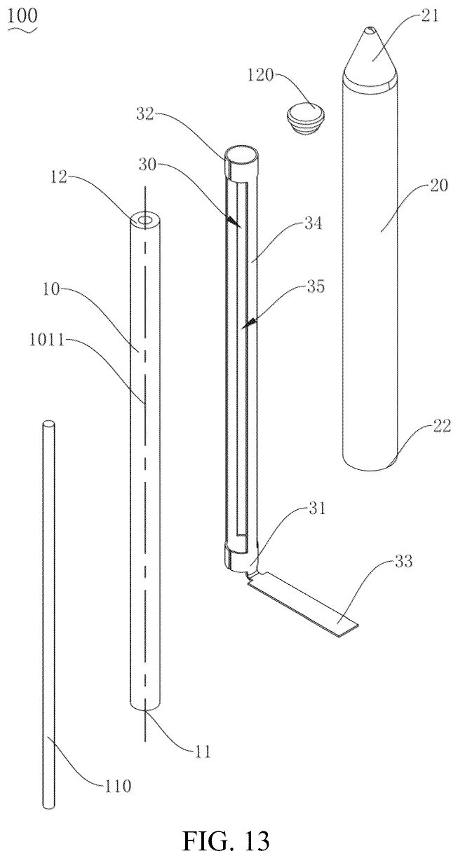

Refer to FIG. 13. Specifically, the inner tube 10 may be a hollow tube member with openings at both ends. The entire inner tube 10 may be in a cylindrical shape with the central axis 1011. The axial length of the inner tube 10 is far greater than the radial length. The side of the inner tube 10 encircles the central axis 1011 of the inner tube 10 for a single turn to form the wall of the inner tube 10 and the hollow space of the inner tube 10.

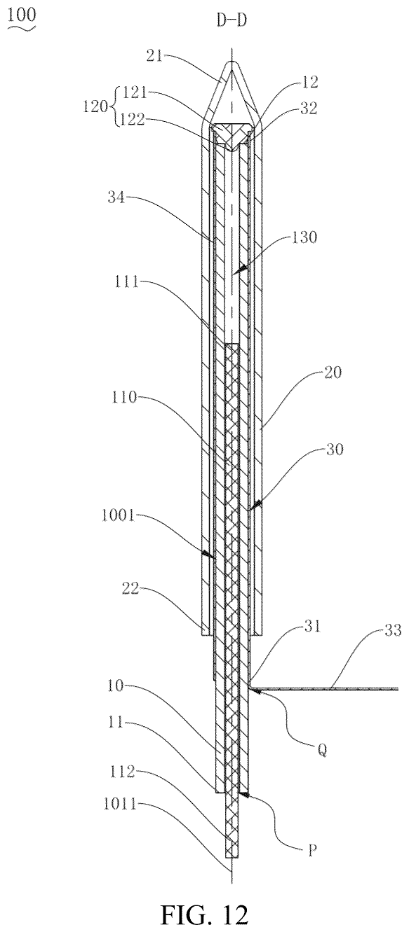

Refer to FIG. 12. At least a portion of the first electrode 110 is inserted into the hollow space at the center of the inner tube 10 from one end of the inner tube 10 in the axial direction of the inner tube 10. As shown in FIG. 12, the position where the first electrode 110 is exposed from the inner tube 10 is denoted as P. The second electrode 120 is disposed at the other end of the inner tube 10, passes through the hollow space of the inner tube 10, and is opposite to the portion of the first electrode 110 that is inserted into the inner tube 10.

The end of the first electrode 110 that is inserted into the inner tube 10 is spaced apart from the second electrode 120 by a particular distance. For ease of description, in this disclosure, the region where the first electrode 110 and the second electrode 120 are spaced apart from each other is defined as the discharge region 130. The discharge region 130 may be enclosed by the inner tube 10 and is located in the hollow space of the inner tube 10.

Refer to FIG. 12 again. With reference to FIG. 1, the first electrode 110 may be connected to the power supply 200 to serve one pole for conducting high-voltage electricity; and the second electrode 120 may be connected to the power supply 200 through the conductive member 30 to serve as the other pole for conducting the high-voltage electricity. When high voltage is applied to the first electrode 110 and the second electrode 120, high-voltage discharge occurs in the discharge region 130 to generate a plasma arc. At the center of the discharge region 130, the maximum temperature during generation of the plasma arc may be above 2000° C., and the stable plasma temperature may range from 1000° C. to 1600° C. The discharge region 130 may be closed and filled with an electrically neutral gas such as nitrogen and argon. Alternatively, the discharge region 130 may be in communication with the atmospheric pressure. In this case, the gas in the discharge region 130 is air.

Refer to FIG. 11 and FIG. 12. The outer tube 20 is sleeved on the inner tube 10 and encloses at least a portion of the inner tube 10. The outer tube 20 may cover at least the discharge region 130 in the inner tube 10. The aerosol generating substrate 300 fills the outer circumference of the outer tube 20. The outer surface of the outer tube 20 may be in direct contact with the aerosol generating substrate 300. The heat generated by the plasma arc in the discharge region 130 can be transferred through the inner tube 10, the conductive member 30, and the outer tube 20 to the outside of the outer tube 20 in a heat transfer manner such as infrared radiation, so that the aerosol generating substrate 300 absorbs the heat to generate an aerosol.

The inner tube 10 encloses at least a portion of the first electrode 110, and the end of the inner tube 10 that includes a second end surface 12 is inserted into the outer tube 20 from the open end 22, to enable the second electrode 120 disposed on the second end surface 12 to abut against the inner wall surface of the tapered end portion 21. A second end portion 32 is connected to the second electrode 120, extends into the outer tube 20 along with the inner tube 10, and is close to the tapered end portion 21. A first end portion 31 may extend out of the outer tube 20 from the open end 22.

The conductive member 30 may be disposed on the inner tube 10, and extends from one end of the inner tube 10 to the other end of the inner tube 10 in the axial direction of the inner tube 10. The path along which the conductive member 30 extends between the two ends of the inner tube 10 may be a straight line, or may be a curve. The outer wall of the partial inner tube 10 enclosed by the outer tube 20 faces the inner wall of the outer tube 20.

The conductive member 30 may be attached to the outer wall of the inner tube 10, located between the outer wall of the inner tube 10 and the inner wall of the outer tube 20, and shield a portion of the outer circumferential surface of the inner tube 10. The partial inner tube 10 shielded by the conductive member 30 cannot face or cannot directly face the outer tube 20. In the region of the inner tube 10 that is shielded by the conductive member 30, the heat of the plasma arc may be transferred through the inner tube 10, the conductive member 30, and the outer tube 20 to the aerosol generating substrate 300.

Infrared radiant energy of this portion is much less than that of the portion not shielded by the conductive member 30.

It may be understood that the conductive member 30 may be a metal member disposed on the outer wall of the inner tube 10. Alternatively, in another embodiment, the conductive member 30 may be a conductive film or a conductive circuit coated on the outer wall of the inner tube 10, and the shape, the thickness, an arrangement position on the inner tube 10, and the like of the conductive member may be understood in the same manner as the foregoing solutions.

At least a portion of the outer wall of the tube segment of the inner tube 10 that corresponds to the conductive member 30 directly faces the inner wall of the outer tube 20. In other words, no other shield members exist between a portion of the outer wall of the tube segment of the inner tube 10 that corresponds to the conductive member 30 and the inner wall of the outer tube 20.

Refer to FIG. 12 to FIG. 14 again. In an aspect, the conductive member 30 includes a first end portion 31 and a second end portion 32 connected to the first end portion 31. The second end portion 32 is connected to the second electrode 120, and the first end portion 31 is configured to be electrically connected to the power supply 200.

The conductive member 30 may be arranged between the first end portion 31 and the second end portion 32 in the axial direction of the inner tube 10. The first end portion 31 is the end of the conductive member 30 that extends out of the outer tube 20 and that is closest to the position where the first electrode 110 is exposed from the inner tube 10 in the axial direction of the inner tube 10. The second end portion 32 of the conductive member 30 may encircle the second electrode 120 or be in contact with the second electrode 120 in another manner, is disposed at one end of the inner tube 10, and is electrically connected to the second electrode 120.

In the axial direction of the inner tube 10, a direction pointing from the second end portion 32 to the first end portion 31 may be defined as a top-to-bottom direction. The tube segment of the inner tube 10 that corresponds to the conductive member 30 may be the tube segment between the first end portion 31 and the second end portion 32.

For example, the second end portion 32 may be in a cylindrical shape, coaxial with the inner tube 10, and encircle and enclose one end of the inner tube 10. The tube segment of the inner tube 10 that is enclosed by the second end portion 32 cannot face the outer tube 20.

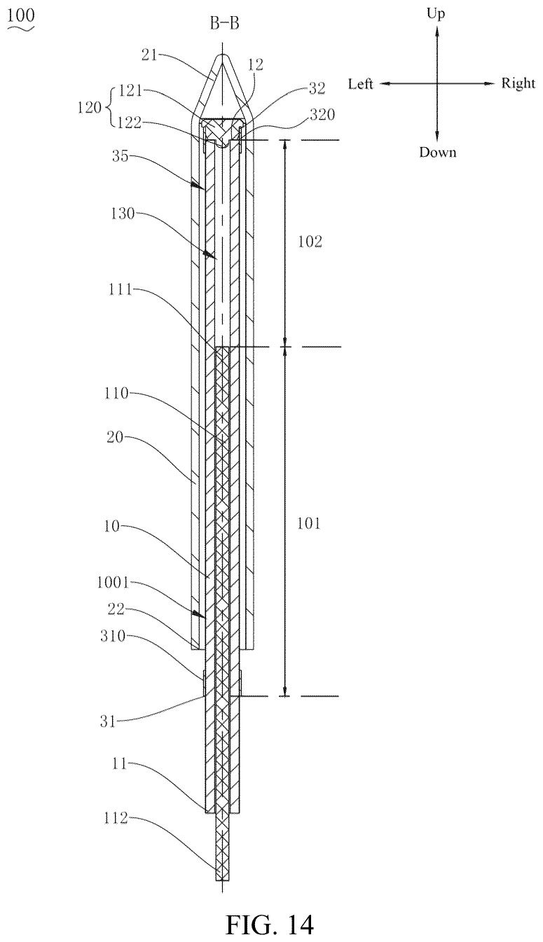

Refer to FIG. 12, FIG. 13, and FIG. 14. In an aspect, the tube segment of the inner tube 10 that corresponds to the conductive member 30 has the outer circumferential surface 1001, and the area of the outer circumferential surface 1001 opposite to the conductive member 30 is smaller than the total area of the outer circumferential surface 1001.

In this way, the area of the outer circumferential surface 1001 opposite to the conductive member 30 is smaller than the total area of the outer circumferential surface 1001, so that the tube segment of the inner tube 10 that corresponds to the conductive member 30 is at least partially not shielded by the conductive member 30 and directly faces the outer tube 20. Therefore, the heat of the plasma in the inner tube 10 can be directly transferred through the partial tube segment of the inner tube 10 and the outer tube 20 to the aerosol generating substrate 300.

Specifically, the inner tube 10 includes a first end surface 11 and a second end surface 12 opposite to the first end surface 11. The first electrode 110 is exposed from the first end surface 11 of the inner tube 10, and the second end surface 12 abuts against one side surface of the second electrode 120. The entire tube segment of the inner tube 10 may be located between the first end surface 11 and the second end surface 12. The second end portion 32 is disposed on the second end surface, and the first end portion 31 may be located between the first end surface 11 and the second end surface 12. The tube segment of the inner tube 10 that corresponds to the conductive member 30 is the partial tube segment between the second end portion 32 and the first end portion 31.

The outer circumferential surface 1001 of the tube segment of the inner tube 10 that corresponds to the conductive member 30 extends from the second end surface 12 to the first end surface in the axial direction of the inner tube 10 until reaching the position where the first end portion 31 is located. It may be understood that the area of the outer circumferential surface 1001 of the tube segment of the inner tube 10 that corresponds to the conductive member 30 may be the product of the outer side length of the second end surface 12 and the distance between the first end portion 31 and the second end portion 32 in the axial direction of the inner tube 10.

The conductive member 30 may be attached to the inner tube 10. For example, the conductive member 30 is formed on the inner tube 10 in a film coating manner, and at least a portion of the outer circumferential surface 1001 of the inner tube 10 is opposite to the conductive member 30. The outer circumferential surface 1001 of the inner tube 10 opposite to the conductive member 30 is shielded by the conductive member 30 between the inner tube and the outer tube 20 in a radial direction of the inner tube 10. The area of the outer circumferential surface 1001 opposite to the conductive member 30 is the area of the region of the inner tube 10 that is shielded by the conductive member 30 between the inner tube 10 and the outer tube 20.

Refer to FIG. 12, FIG. 13, and FIG. 14 again. In an aspect, the tube segment of the inner tube 10 that corresponds to the conductive member 30 has the outer circumferential surface 1001, and the conductive member 30 partially covers the outer circumferential surface 1001.

Specifically, the conductive member 30 is in close contact with the outer wall of the inner tube 10. The outer circumferential surface 1001 of the tube segment of the inner tube 10 that corresponds to the conductive member 30 is partially covered by the conductive member 30. The conductive member 30 may extend on the outer circumferential surface 1001 of the inner tube 10 in the axial direction of the inner tube 10, and extend from the first end surface 11 to the second end surface 12 to form a straight strip-shaped extension path. Alternatively, the extension path of the conductive member 30 on the outer circumferential surface 1001 of the inner tube 10 may be a curve that encircles the central axis 1011 of the inner tube 10 and that protrudes toward the outer tube 20. The extension path of the conductive member 30 covers a portion of the outer circumferential surface 1001 of the inner tube 10.

Refer to FIG. 11 and FIG. 14. In an aspect, the inner tube 10 includes a first tube segment 101 and a second tube segment 102 connected to the first tube segment 101. The first electrode 110 is at least partially inserted into the first tube segment 101. The second electrode 120 is disposed at the end of the second tube segment 102 away from the first tube segment 101 and is disposed opposite to and spaced apart from the first electrode 110. The second electrode 120 and the first electrode 110 are controlled to generate plasma at least in the second tube segment 102, and the outer circumferential surface of the first tube segment 101 partially faces the outer tube 20.

It should be noted that in this disclosure, the description of division of the inner tube 10 into the first tube segment 101 and the second tube segment 102 is not intended to limit the inner tube 10 as a combination of the two separate parts. Preferably, the inner tube 10 is an integral tube, namely, an integrally formed tube body. This division is provided merely for the purpose of better describing the subsequent solutions, and does not constitute a limitation to whether the inner tube 10 is an integral or split structure.

Specifically, the first tube segment 101 may be the partial tube segment extending in the axial direction of the inner tube 10 from the first end portion 31 to the end of the first electrode 110 that faces the second electrode 120. The second tube segment 102 may be the partial tube segment extending in the axial direction of the inner tube 10 from the end of the first electrode 110 that faces the second electrode 120 to the second end surface 11.

The second electrode 120 is disposed at the end of the second tube segment 102 that includes the second end surface 12. The second electrode 120 and the first electrode 110 are controlled to generate plasma in the second tube segment 102. Therefore, the discharge region 130 is located in the second tube segment 102.

The conductive member 30 is connected to the second electrode 120 at the second tube segment 102, extends from the second tube segment 102 to the first tube segment 101, and extends out of the outer tube 20 from the open end 22. The path along which the conductive member 30 extends from the second tube segment 102 to the first end surface 11 covers the outer circumferential surface of the partial first tube segment 101. The outer circumferential surface of the first tube segment 101 that is uncovered by the conductive member 30 faces the outer tube 20.

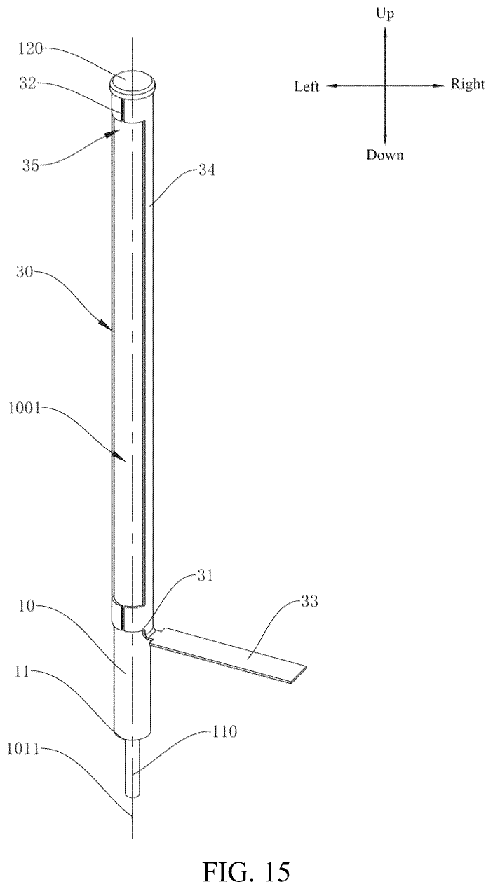

Refer to FIG. 13 and FIG. 15. In an aspect, the conductive member 30 is provided with a hollowed-out portion 35, and a portion of the first tube segment 101 is exposed through the hollowed-out portion 35 and faces the outer tube 20.

With reference to FIG. 11, the upper portion of the heating assembly 100 is inserted into the aerosol generating substrate 300, and the upper portion of the heating assembly 100 includes the discharge region 130. The lower portion of the heating assembly 100 may be used for mounting and fixing. In the related technology, the heat generated in the discharge region is easily transferred to the lower portion of the heating assembly through the conductive member, resulting in excessively high temperature of the lower portion of the heating assembly and significant energy waste. In addition, a large amount of liquid is easily accumulated.

In this way, the conductive member 30 is provided with the hollowed-out portion 35, which can prevent the heat of the conductive member 30 from being transferred from the discharge region 130 to the lower portion of the heating assembly 100, thereby avoiding excessively high temperature of the lower portion of the heating assembly 100, improving utilization of the heat for heating the aerosol generating substrate 300, and reducing deposition of condensates. The hollowed-out portion 35 further helps enhance the intensity of external radiation of the plasma arc.

Refer to FIG. 11 and FIG. 14. The heating assembly 100 generates a plasma arc through discharge between the first electrode 110 and the second electrode 120, to heat the aerosol generating substrate 300. At the center of the discharge region 130, the maximum temperature of the plasma arc can reach 2000° C., and the heat is concentrated. It may be understood that the heat capacity of the heating assembly 100 needs to be minimized, so that the discharge region 130 is less likely to accumulate heat, and the heat can be quickly transferred to the aerosol generating substrate 300. Meanwhile, the heating assembly 100 needs to reduce the heat transfer to other portions than the aerosol generating substrate 300.

Refer to FIG. 11 and FIG. 15. In some embodiments, the conductive member 30 is in a tubular shape and sleeved on the inner tube 10, and the first end portion 31 and the second end portion 32 are the two axial end portions of the conductive member 30, respectively. The first end portion 31 encircles the outer circumference of the first end surface 11, and the second end portion 32 extends out of the open end 22 and is partially located outside the outer tube 20. The hollowed-out portion 35 is located between the first end portion 31 and the second end portion 32, and the outer surface of the inner tube 10 between the first end portion 31 and the second end portion 32 is exposed through the hollowed-out portion 35 and faces the outer tube 20.

Refer to FIG. 14 and FIG. 15. In some embodiments, the conductive member 30 is sleeved on the inner tube 10, may be in a cylindrical shape at the second tube segment 102, and covers at least a portion of the second tube segment 102. The discharge region 130 is located at the second tube segment 102, and heat from the discharge region 130 can be transferred through the second tube segment 102, the conductive member 30, and the outer tube 20 to the aerosol generating substrate 300. The hollowed-out portion 35 extends from the end surface of the first electrode 110 that faces the second electrode 120 to the second end portion 32. The outer circumferential surface of the first tube segment 101 is exposed through the hollowed-out portion 35 and faces the inner wall of the outer tube 20. The heat generated in the discharge region 130 is not readily transferred downward through the hollowed-out portion 35.

Specifically, the conductive member 30 may be a metal tube coaxial with the inner tube 10, so that the center of the discharge region 130 is approximately located on the central axis 1011 of the conductive member 30 and the inner tube 10, to achieve uniform heat conduction.

The first end portion 31 and the second end portion 32 are connected through a conductive strip 34. The conductive strip 34 is in contact with the outer wall surface of the inner tube 10 and extends in the axial direction of the inner tube 10. The first end portion 31 and the second end portion 32 may be in a ring shape, encircle the central axis 1011 of the inner tube 10, and enclose the outer wall of the inner tube 10.

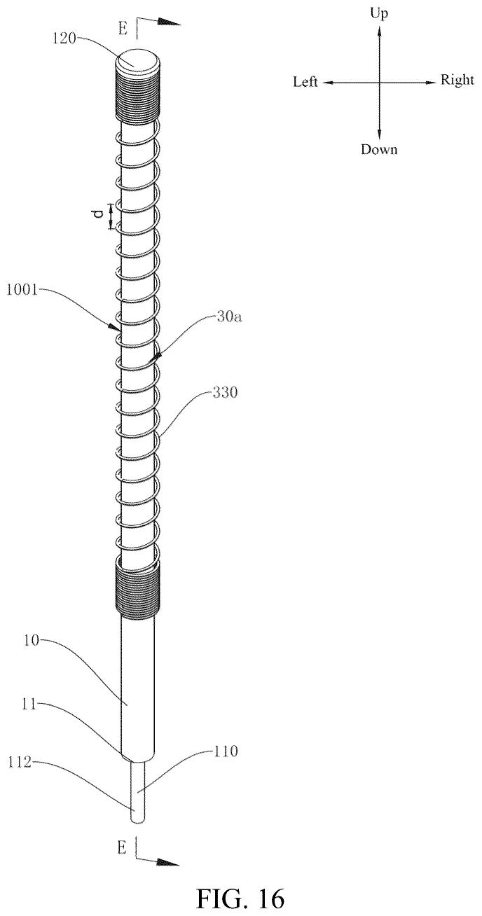

Refer to FIG. 16. In some embodiments, the conductive member 30 may be a wire with stiffness lower than that of a metal tube. The conductive member 30 may be wound around the inner tube 10 to form a tubular shape, and enclose the first tube segment 101 and the second tube segment 102. The wires are arranged at intervals to form hollowed-out portions.

In some embodiments, the shape of the hollowed-out portion 35 includes, but is not limited to, a circular hole shape, an elliptical hole shape, an irregular hole shape, a straight-edged strip shape, a curved-edged strip shape, and the like. The hollowed-out portions 35 on one conductive member 30 may be in the same shape, or may be in different shapes.

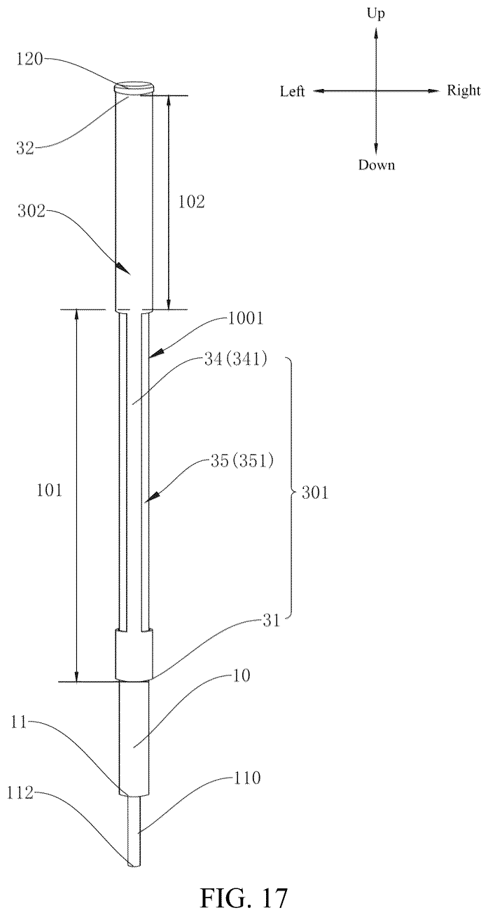

Refer to FIG. 17. In an aspect, a plurality of hollowed-out portions 35 are provided. The plurality of hollowed-out portions 35 are arranged at intervals in a circumferential direction of the inner tube 10.

In this way, the plurality of hollowed-out portions 35 can further reduce the volume of the conductive member 30, lower the heat capacity, and accelerate the heating of the aerosol generating substrate 300.

Specifically, the conductive member 30 may form the hollowed-out portions 35 between the first end portion 31 and the second end portion 32. The plurality of hollowed-out portions 35 are formed by arranging a plurality of conductive strips 34 at intervals. The plurality of conductive strips 34 may be distributed at intervals on the outer circumferential surface 1001 of the inner tube 10 in the circumferential direction of the inner tube 10.

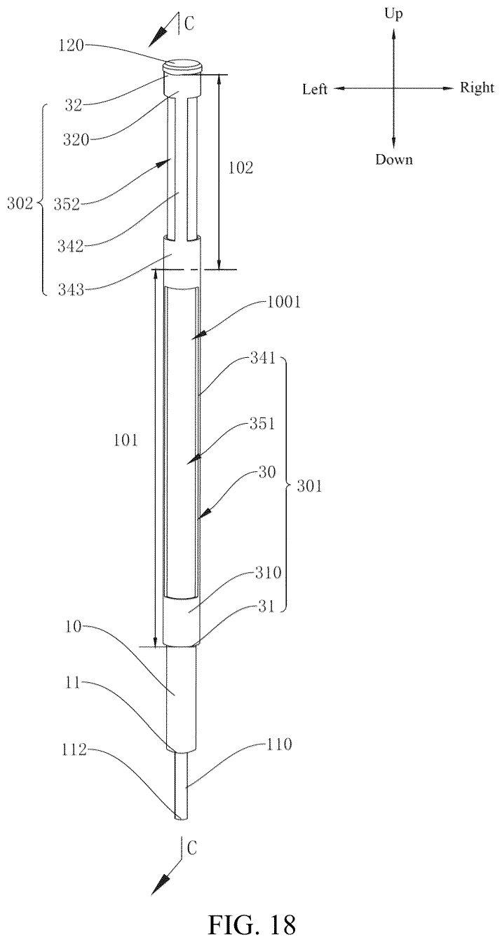

Refer to FIG. 17 and FIG. 18. In some embodiments, the conductive strips 34 and the hollowed-out portions 35 extend side by side on the outer circumferential surface of the first tube segment 101, extend in an axial direction of the first tube segment 101, and are arranged at intervals in a circumferential direction of the first tube segment 101.

Refer to FIG. 14 and FIG. 15. In an aspect, the hollowed-out portions 35 may extend from the first end portion 31 to the second end portion 32 in the axial direction of the inner tube 10, so that the area of the outer circumferential surface 1001 facing the outer tube 20 is larger.

In an aspect, the wall thickness of the conductive member 30 ranges from 0.05 mm to 0.2 mm. In this way, the heat capacity can be lowered to improve the energy utilization efficiency during heating.

Exemplarily, the wall thickness of the conductive member 30 may range from 0.05 mm to 0.19 mm, from 0.06 mm to 0.18 mm, from 0.07 mm to 0.17 mm, from 0.08 mm to 0.16 mm, from 0.09 mm to 0.15 mm, from 0.10 mm to 0.14 mm, from 0.11 mm to 0.13 mm, or from 0.115 mm to 0.125 mm. For example, the wall thickness of the conductive member 30 may be 0.05 mm, 0.08 mm, 0.10 mm, 0.12 mm, 0.15 mm, 0.16 mm, or 0.2 mm.

Further, the wall thickness of the conductive member 30 preferably ranges from 0.05 mm to 0.1 mm. For example, the wall thickness of the conductive member 30 is 0.055 mm, 0.06 mm, 0.07 mm, or 0.09 mm.

It may be understood that as the wall thickness of the conductive member 30 increases, the volume increases correspondingly, and a larger amount of heat can be absorbed and stored, resulting in high heat capacity of the heating assembly 100. When the wall thickness of the conductive member 30 is less than or equal to 0.2 mm, the conductive member is less likely to store heat, which helps the conductive member 30 transfer the heat from the discharge region 130 to the aerosol generating substrate 300. When the wall thickness of the conductive member 30 is greater than or equal to 0.05 mm, the conductive member is less prone to wear and failure.

In some embodiments, the conductive member 30 is made of an oxidation-resistant metal material, which can prevent the conductive member 30 from oxidation failure and prolong the service life. Specifically, the conductive member 30 is made of at least one of nickel-based alloys and iron-based alloys.

Refer to FIG. 17 and FIG. 18. In an aspect, the conductive member 30 includes a first conductive portion 301 corresponding to the first tube segment 101. The first conductive portion 301 is provided with a first hollowed-out portion 351, a portion of the first tube segment 101 is exposed through the first hollowed-out portion 351 and faces the outer tube 20, and the hollowed-out portion 35 includes the first hollowed-out portion 351.

In this way, with reference to FIG. 11, the first hollowed-out portion 351 interrupts the path along which the partial first conductive portion 301 transfers heat to the region away from the aerosol generating substrate 300, thereby reducing heat waste.

Specifically, the first hollowed-out portion 351 may be formed by cutting the tube wall of the first conductive portion 301. The first hollowed-out portion 351 may be in a strip shape. The number of first hollowed-out portions 351 may be one or more.

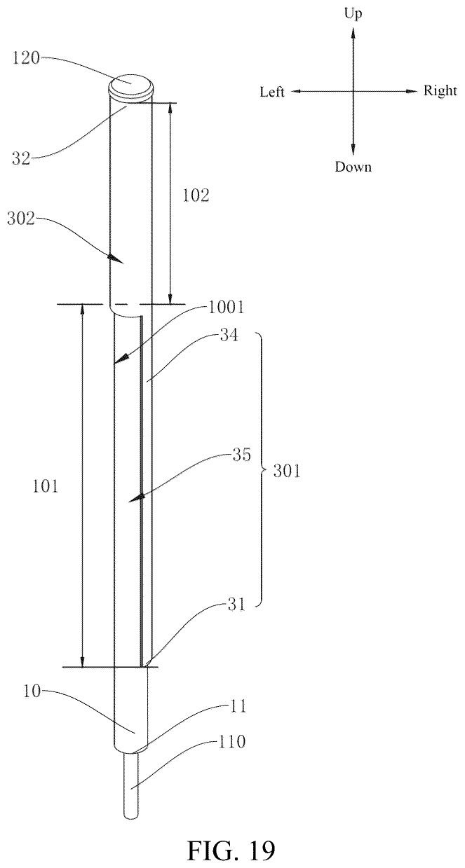

Refer to FIG. 19. For example, in some embodiments, the number of conductive strips 34 of the first tube segment 101 is one. One conductive strip forms one hollowed-out portion. The hollowed-out portion extends from one side of the conductive strip 34 to the other side of the conductive strip 34 in the circumferential direction of the first tube segment 101.

Refer to FIG. 12 and FIG. 18. For another example, in some embodiments, the number of conductive strips 34 of the first tube segment 101 is two, and the two conductive strips 34 may be distributed at two ends of the same diameter of the inner tube 10 and spaced apart to form two hollowed-out portions 35. The outer wall of the inner tube 10 is exposed through the hollowed-out portions 35 and faces the inner wall of the outer tube 20.

Refer to FIG. 18 again. In an aspect, the first conductive portion 301 includes a plurality of first conductive strips 341. The plurality of first conductive strips 341 extend in the axial direction of the first tube segment 101, and the plurality of first conductive strips 341 are arranged at intervals in the circumferential direction of the first tube segment 101. The first hollowed-out portion 351 is formed between two adjacent first conductive strips 341.

In this way, the plurality of first conductive strips 341 may be spaced apart to form a plurality of first hollowed-out portions 351, thereby reducing downward heat transfer of the first conductive portion 301.

Specifically, the plurality of first conductive strips 341 may extend from the first end portion 31 to the end surface of the first electrode 110 opposite to the second electrode 120. The areas of the outer circumferential surfaces of the first tube segment 101 that are covered by the plurality of first conductive strips 341 may be the same, or may be different. The plurality of first conductive strips 341 are arranged at equal intervals in the circumferential direction of the first tube segment 101, to form hollowed-out portions 35 of equal size. Alternatively, the intervals between every two adjacent first conductive strips 341 may be unequal.

The total area of the outer circumferential surfaces of the first tube segment 101 that are covered by the plurality of first conductive strips 341 is smaller than the total area of the outer circumferential surfaces of the first tube segment 101 that are exposed through the first hollowed-out portions 351 and faces the outer tube.

Refer to FIG. 17 to FIG. 20. In an aspect, the conductive member 30 includes a second conductive portion 302 connected to the first conductive portion 301. The second conductive portion 302 encloses at least a portion of the second tube segment 102.

In this way, the second conductive portion 302 covers the region where the plasma arc is generated in the second tube segment 102, thereby improving the utilization efficiency of the radiated heat.

Specifically, the second conductive portion 302 is connected to the second electrode 120 at the second end surface 12, and extends from the second electrode 120 to the first tube segment 101. The second conductive portion 302 encloses the second tube segment 102 and completely covers the outer circumferential surface of the second tube segment 102.

In some embodiments, the second conductive portion 302 is in a cylindrical shape and coaxial with the second tube segment 102.

As described above, the discharge region 130 is located between the end of the first electrode 110 that extends into the inner tube 10 and the second electrode 120. When high voltage is applied to the first electrode 110 and the second electrode 120, a plasma arc is generated in the discharge region 130. In the following description, L denotes the arc length of the plasma arc generated between the first electrode 110 and the second electrode 120, namely, the discharge arc length.

It may be understood that the discharge arc length is approximately equal to the distance between the first electrode 110 and the second electrode 120 in the axial direction of the inner tube 10. The distance between the first electrode 110 and the second electrode 120 in the axial direction of the inner tube 10 may be fixed. Therefore, the discharge arc length may be a fixed value.

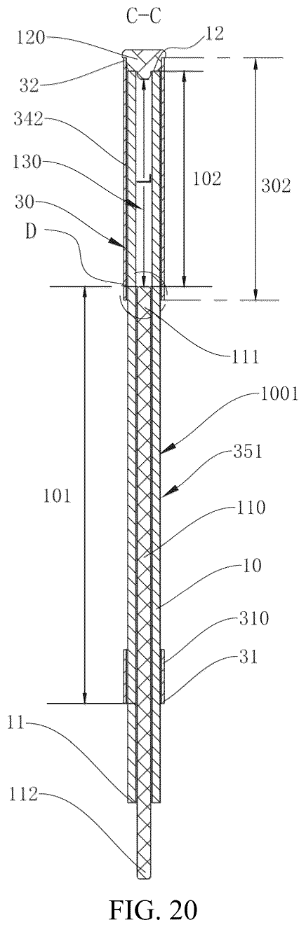

Refer to FIG. 20. In some embodiments, the discharge arc length between the second electrode 120 and the first electrode 110 satisfies 2 mm≤L≤10 mm.

In this way, the discharge arc length falls within a controlled range, thereby ensuring that discharge performance of the first electrode 110 and the second electrode 120 and temperature field distribution in the region of the discharge arc length are favorable.

Specifically, the discharge arc length between the second electrode 120 and the first electrode 110 may be any length not less than 2 mm and not greater than 10 mm. For example, the discharge arc length may range from 3 mm to 10 mm, from 4 mm to 8 mm, from 5 mm to 7 mm, or from 5.5 mm to 6 mm. Exemplarily, the discharge arc length may be 2 mm, 3 mm, 4 mm, 5 mm, 6 mm, 8 mm, 9 mm, or 10 mm. The discharge region 130 is located in the inner tube 10, and the length of the inner tube 10 is apparently greater than the discharge arc length. The outer tube 20 is sleeved on the inner tube 10 and covers the entire discharge region 130. The outer tube 20 is inserted into the aerosol generating substrate 300, and the outer tube 20 inserted into the aerosol generating substrate 300 includes at least the tube body end portion covering the discharge region 130.

In some embodiments, the discharge arc length between the second electrode 120 and the first electrode 110 satisfies 6 mm<L≤10 mm.

Exemplarily, the discharge arc length ranges from 6 mm to 9 mm, from 7 mm to 8.5 mm, or from 7.5 mm to 8 mm. For example, the discharge arc length may be 6.1 mm, 7.5 mm, 8.6 mm, 9.8 mm, or 10 mm.

In an aspect, the discharge arc length L between the second electrode 120 and the first electrode 110 is equal to 8 mm.

The second conductive portion 302 covers the second tube segment 102 and extends in an axial direction of the second tube segment 102 by the length greater than the discharge arc length L, so that the length of the plasma arc does not exceed the length of the second conductive portion 302.

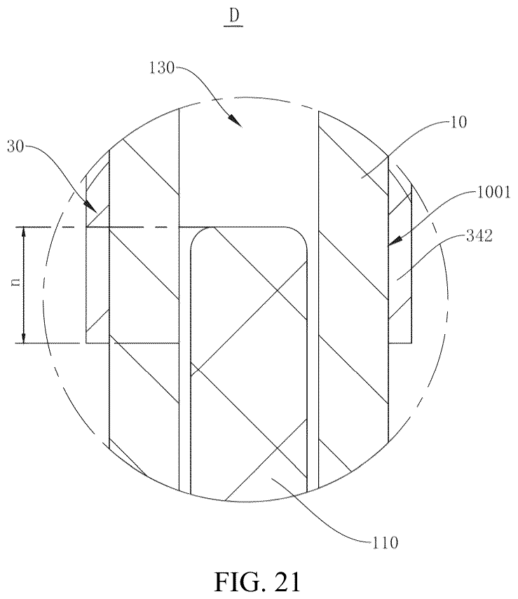

Refer to FIG. 20 and FIG. 21. In an aspect, in the axial direction of the inner tube 10, the second conductive portion 302 overlaps with the end portion of the first electrode 110 that faces the second electrode 120. In the following description, n denotes the overlapping dimension between the second conductive portion 302 and the end portion of the first electrode 110 that faces the second electrode 120.

In this way, the risk of discharge between the second conductive portion 302 and the end portion of the first electrode 110 that faces the second electrode 120 can be reduced.

It should be noted that, if a direction pointing from the second end surface to the first end surface in the axial direction of the inner tube 10 is defined as a top-to-bottom direction, the end portion of the first electrode 110 that faces the second electrode 120 is the upper end of the first electrode 110, and the second conductive portion 302 is located above the first electrode 110 in the axial direction of the inner tube. That, in the axial direction of the inner tube 10, the second conductive portion 302 overlaps with the end portion of the first electrode 110 that faces the second electrode 120 may be understood as that the position of the lower end of the second conductive portion 302 is lower than the position of the upper end of the first electrode 110 in the axial direction of the inner tube 10.

It may be understood that, with reference to FIG. 1, the second electrode 120 is connected to the power supply 200 through the conductive member 30. When the first electrode 110 and the second electrode 120 are energized, the second electrode 120 and the first electrode 110 are opposite to each other and carry opposite polarities. Therefore, an electric field is established between the second electrode 120 and the first electrode 110. The second electrode 120 carries the same polarity as the second conductive portion 302, and discharge may occur when the second conductive portion 302 is spaced apart from the end portion of the first electrode that faces the second electrode 120 by a particular non-insulated distance.

The second conductive portion 302 is configured to cover, in the axial direction of the inner tube 10, the end surface of the first electrode 110 that faces the second electrode 120. The second conductive portion 302 overlaps with the end portion of the first electrode 110 that faces the second electrode 120, so that the space between the second conductive portion 302 and the end portion of the first electrode 110 that faces the second electrode 120 is filled by the side wall of the inner tube 10 to enhance insulation.

Refer to FIG. 20 and FIG. 21. In an aspect, in the axial direction of the inner tube 10, the overlapping dimension between the second conductive portion 302 and the end portion of the first electrode 110 that faces the second electrode 120 satisfies n≥0.3 mm.

In this way, the end surface of the second conductive portion 302 is not opposite to the end surface of the first electrode 110, which lowers the probability of discharge between the second conductive portion 302 and the first electrode 110, thereby enhancing the dielectric strength between the second conductive portion 302 and the end portion of the first electrode 110 that faces the second electrode 120.

Specifically, the overlapping dimension between the second conductive portion 302 and the end portion of the first electrode 110 that faces the second electrode 120 may refer to the distance between the position on the second conductive portion 302 farthest from the second end surface 12 in the axial direction of the inner tube 10 and the projection of the end surface of the first electrode 110 that faces the second electrode 120 onto the outer wall of the inner tube 10.

The overlapping dimension n between the second conductive portion 302 and the end portion of the first electrode 110 that faces the second electrode 120 may range from 0.3 mm to 0.4 mm, from 0.4 mm to 0.5 mm, from 0.5 mm to 0.6 mm, or the like. For example, the overlapping dimension n between the second conductive portion 302 and the end portion of the first electrode 110 that faces the second electrode 120 may be 0.3 mm, 0.35 mm, 0.4 mm, 0.5 mm, or 0.55 mm.

Refer to FIG. 17 and FIG. 18 again. In an aspect, the conductive member 30 includes a second conductive portion 302 connected to the first conductive portion 301. The second conductive portion 302 corresponds to the second tube segment 102, the second conductive portion 302 is provided with a second hollowed-out portion 352, a portion of the second tube segment 102 is exposed through the second hollowed-out portion 352 and faces the outer tube 20, and the hollowed-out portion 35 includes the second hollowed-out portion 352.

In this way, the heat capacity of the conductive member 30 can be further lowered, and the time required for the heating assembly 100 to heat up and cool down can be shortened.

Specifically, the second hollowed-out portion 352 may be in a straight strip shape, a curve shape, a circular hole shape, or the like. The number of second hollowed-out portions 352 may be one, two, three or more. The portion of the outer circumferential surface of the second tube segment 102 that is covered by the second conductive portion 302 is in close contact with the second conductive portion 302 and is covered by the second conductive portion 302. The portion of the outer circumferential surface of the second tube segment 102 that is uncovered by the second conductive portion 302 may be exposed through the second hollowed-out portion 352 and faces the inner wall of the outer tube 20.

Refer to FIG. 18 and FIG. 20. In an aspect, the second conductive portion 302 includes a plurality of second conductive strips 342. The plurality of second conductive strips 342 extend in an axial direction of the second tube segment 102, the plurality of second conductive strips 342 are arranged at intervals in a circumferential direction of the second tube segment 102, and the second hollowed-out portion 352 is formed between two adjacent second conductive strips 342. In this way, the thermal resistance to outward heat conduction from the high-temperature arc at the center of the discharge region 130 can be further lowered, thereby increasing the heating rate.

Specifically, the second conductive strip 342 and the second hollowed-out portion 352 may be formed by cutting a metal tube body. In the circumferential direction of the second tube segment 102, the second conductive strip 342 and the second hollowed-out portion 352 may be arranged in sequence. One end of the second conductive strip 342 may be connected to the second end portion 32, and extend from the second end surface 12 to a position below the end surface of the first electrode 110 that faces the second electrode 120. One side edge of the second conductive strip 342 may be parallel to the central axis of the inner tube. The second hollowed-out portion 352 is formed at a position between the adjacent side edges of two adjacent second conductive strips 342.

The number of second conductive strips 342 may be two, three, four, five or more. The plurality of second conductive strips 342 form a plurality of second hollowed-out portions 352. Correspondingly, the number of second hollowed-out portions 352 is the same as the number of second conductive strips 342.

Refer to FIG. 18. In an aspect, a connecting ring 343 is formed at the junction between the first conductive portion 301 and the second conductive portion 302, and the connecting ring 343 covers, in the circumferential direction of the inner tube 10, the end portion of the first electrode 110 that faces the second electrode 120.

In this way, by providing the connecting ring 343, the local electric field intensity can be reduced to avoid discharge breakdown between the first electrode 110 and the conductive member 30. In addition, the mechanical strength of the conductive member 30 can be enhanced, thereby reducing the risk of deformation and failure of the conductive member 30.

Specifically, the connecting ring 343 may be a partial conductive member that is retained when the hollowed-out portions 35 are formed by cutting the tube wall of the conductive member 30 and that covers the circumference of the end portion of the first electrode 110 that faces the second electrode 120.

According to the following formula, the relationship between the side wall area and the electric field intensity is described as that the field intensity increases as the side wall area decreases; or the field intensity decreases as the side wall area increases.

$$E = \frac{U}{d} = \frac{Q 4 π k}{ε S} ,$$

where E denotes the electric field intensity, U denotes voltage applied to the two electrodes, d denotes a discharge distance, Q denotes charges carried by the electrode, S denotes the discharge area, k denotes an electrostatic constant, and ε denotes a dielectric constant of a medium between the two electrodes.

It may be understood that the conductive member 30 forms the hollowed-out portion 35, and the electric field intensity between the side walls increases as the side wall area decreases. Consequently, breakdown is more likely to occur between the first electrode 110 and the conductive member 30, thereby reducing the stability and safety of the heating assembly 100. The connecting ring 343 covers the discharge end of the first electrode 110, which can reduce the intensity of the local electric field formed around the circumference of the discharge end of the first electrode 110, thereby avoiding breakdown between the first electrode 110 and the conductive member 30.

Refer to FIG. 14 and FIG. 15. In an aspect, the hollowed-out portion 35 extends from the first tube segment 101 to the end portion of the second tube segment 102 away from the first tube segment 101, and a portion of the second tube segment 102 is exposed through the hollowed-out portion 35 and faces the outer tube 20.

In this way, with reference to FIG. 11 and FIG. 1, the heat transfer path at the lower portion of the conductive member 30 can be interrupted to the greatest extent, thereby reducing downward heat transfer and improving the utilization of the heat for heating the aerosol generating substrate 300.

Specifically, the hollowed-out portion 35 may be formed by cutting the side wall of the tube body of the conductive member 30. The portion of the conductive member 30 around the circumference of the second electrode may be retained to form a second conductive ring 320, which is configured to be connected to the second electrode 120. The partial conductive tube wall of the end portion of the conductive member 30 closest to the first end surface 11 may be retained to form a first conductive ring 310, which is configured to be connected to the power supply 200. The first conductive ring 310 may be exposed from the outer tube 20.

As shown in FIG. 15 and FIG. 18, the first conductive ring 310 and the second conductive ring 320 are connected to each other through a conductive strip 34. The number of conductive strips 34 configured to be connected to the first conductive ring 310 and the second conductive ring 320 may be one. A hollowed-out portion 35 is formed between the first conductive ring 310 and the second conductive ring 320, and the outer circumferential surfaces of the first tube segment 101 and the second tube segment 102 are exposed through the hollowed-out portion 35 and face the outer tube 20.

As shown in FIG. 12 and FIG. 13, in some embodiments, the conductive member 30 includes a connecting wire 33 connected to the first conductive ring 310. The connecting wire 33 is electrically connected to the power supply 200. The stiffness of the connecting wire 33 may be lower than the stiffness of the tube body of the conductive member 30. The connecting wire 33 may extend in the radial direction of the inner tube 10. Alternatively, the connecting wire 33 may extend on the outer tube 20 in a direction away from the conductive end 112 of the first electrode 110.

Refer to FIG. 15. In an aspect, at least a portion of the conductive member 30 is in a cylindrical shape, and the conductive member 30 is sleeved on the inner tube 10.

In this way, it is easily to assemble the conductive member 30 with the inner tube 10 to form a compact structure, thereby facilitating the miniaturization of the heating assembly 100.

Specifically, the conductive member 30 may be in a cylindrical shape and coaxial with the inner tube 10. The inner tube 10 is nested in the conductive member 30.

Refer to FIG. 21. In an aspect, the conductive member 30 is in close contact with the outer wall of the inner tube 10. The size of a gap between the conductive member 30 and the outer wall of the inner tube 10 is less than or equal to 0.1 mm. A plasma arc is generated between the first electrode 110 and the second electrode 120 in the discharge region 130, and the maximum temperature can reach 2000° C. A large amount of heat from the center of the discharge region 130 is transferred or radiated through the inner tube 10, the conductive member 30, and the outer tube 20 to the aerosol generating substrate 300 around the circumference of the outer tube 20. The conductive member 30 is in close contact with the outer wall of the inner tube 10, resulting in high heat conduction efficiency. In addition, by keeping the conductive member 30 close to the inner tube 10, or closely adhering the conductive member 30 to the inner tube 10, contact between the conductive member 30 and the inner wall of the outer tube 20 can be effectively avoided, thereby avoiding non-uniform temperature field distribution of the outer tube 20.

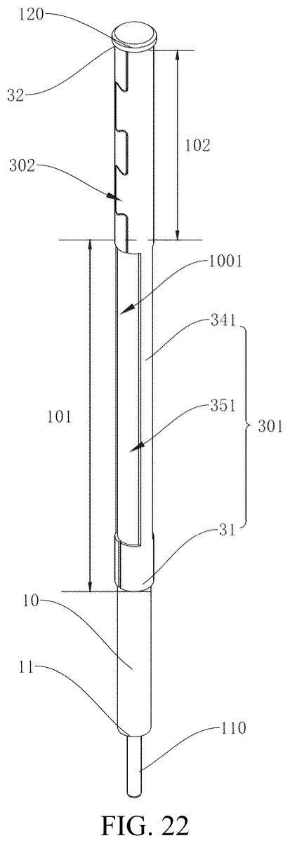

Refer to FIG. 22. In an aspect, the cylindrical portion of the conductive member 30 is manufactured by winding and is sleeved on the inner tube 10.

In this way, the assembly tightness between the conductive member 30 and the inner tube 10 can be improved, which is beneficial to heat conduction.

Specifically, the conductive member 30 may be formed by winding sheet metal. The sheet metal may be wound around the central axis 1011, and the wound sheet metal encircles the inner tube for a single turn to form a cylindrical or annular conductive tube body. The conductive tube body may have a gap in the axial direction of the inner tube 10, so that the cross-section of the conductive member 30 in the radial direction of the inner tube 10 is “C”-shaped, which is beneficial to adjustment of the diameter of the tube body formed by winding, and adjustment of the assembly tightness between the conductive member 30 and the inner tube 10.

Refer to FIG. 16. In an aspect, the conductive member 30 includes a conductive wire 330. The conductive wire 330 encircles the inner tube 10 and is formed with a hollowed-out portion 35, and the tube segment of the inner tube 10 that corresponds to the conductive member 30 is partially exposed through the hollowed-out portion 35 and faces the outer tube 20.

In this way, the heat capacity can be lowered through the conductive wire 330, thereby accelerating the heating and cooling.

Specifically, the conductive wire 330 encircles the inner tube, to partition the outer circumferential surface 1001 of the tube segment of the inner tube 10 that corresponds to the conductive member 30 into different blocks, so as to form the hollowed-out portion.

In some embodiments, the upper end of the conductive member 30 is connected to the second electrode 120, and the lower end is located near the open end 22 of the outer tube 20. The conductive member 30 may extend out of the outer tube 20 from the open end 22 and is connected to the power supply 200. Alternatively, the conductive member 30 may encircle the inner tube 10 from the second end surface 12 to the open end 22. The connection point between the conductive member 30 and the second electrode 120 and the position where the conductive member 30 extends from the open end 22 may be on the same side of the inner tube 10, or may be on opposite sides of the inner tube 10.

Specifically, the conductive member 30 may be formed by one conductive wire 330, two conductive wires 330, three conductive wires 330, or more conductive wires encircling the inner tube 10.

In a case that the number of conductive wires 330 is one, the conductive wire 330 encircles the outside of the inner tube 10 for at least one turn. In an aspect, the conductive wire 330 encircles the discharge region 130 for two or more turns. Alternatively, the conductive wire 330 may extend between the second electrode 120 and the opening of the outer tube 20 along a near-straight path. The portions of the inner tube 10 that are uncovered by the conductive wire 330 all face the inner wall of the outer tube 20.

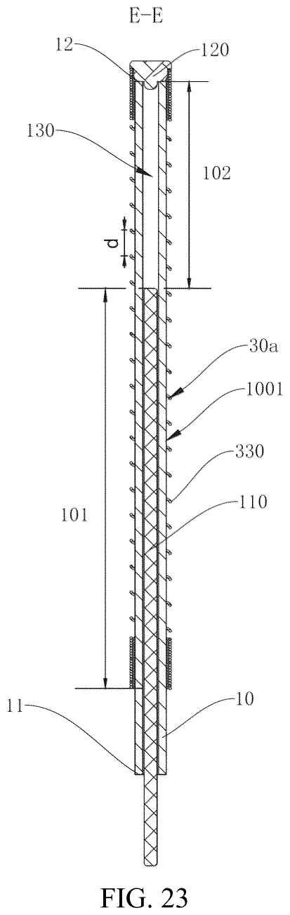

Refer to FIG. 16 and FIG. 23. In an aspect, the conductive wire 330 is wound to form a helical coil 30a, and at least some of pitches of the helical coil 30a are greater than 0, thereby forming the hollowed-out portion 35.

The conductive wire 330 forms the helical coil 30a, which facilitates assembly of the conductive wire with the inner tube 10. In addition, the heat capacity of the conductive member 30 may be lowered by adjusting the pitch of the helical coil 30a, thereby reducing heat stored in the conductive member 30 and increasing the heating rate.

Specifically, the conductive wire 330 may be wound around the inner tube 10 and extend from the second end surface 12 to the first end surface 11, to form the helical coil 30a. The pitch of the helical coil 30a may refer to a distance between two consecutive turns of the conductive wire 330 wound around the inner tube in the axial direction of the inner tube.

It may be understood that as the conductive wire 330 is wound more loosely, the pitch of the formed helical coil 30a increases. Consequently, the heat capacity of a conductive helical structure is reduced, the area of the outer circumferential surface 1001 covered by the conductive wire 330 increases, leading to a higher heating rate.

Refer to FIG. 16 and FIG. 23 again. In an aspect, in an axial direction of the helical coil 30a, the pitch of the middle portion of the helical coil 30a is greater than the pitch of at least one end.

In this way, heat capacity distribution of the conductive member and a temperature field of the heating assembly 100 may be adjusted through the unequal pitches, thereby increasing the heating rate and reducing heat conduction from the discharge region to components other than the aerosol generating substrate 300.

Specifically, one end of the helical coil 30a is fixed to the outer circumference of the second electrode 120, and the other end of the helical coil 30a may be fixed to a position between the first end surface 11 and the second end surface 12 on the outer circumference of the inner tube 10, with an axial distance from the first end surface 11 greater than 2 mm. The pitch of a helical coil 30a in the middle portion between two ends may be greater than the pitch at each end.

In an aspect, the conductive wire 330 is connected to the second electrode 120, and is closely wound on the circumference of the second end surface 12 to stabilize the connection. The pitch of the helical coil 30a formed on the outer circumference of the second electrode 120 is close to 0. The pitch of the helical coil 30a sleeved on the tube segment below the discharge region 130 is increased, thereby lowering the heat capacity of the conductive helical coil 30a, increasing the radiation area of the inner tube 10 facing the outer tube 20, and increasing the heating rate.

Further, the helical tube body may be in a close fit with or nested on the tube body of the inner tube 10.

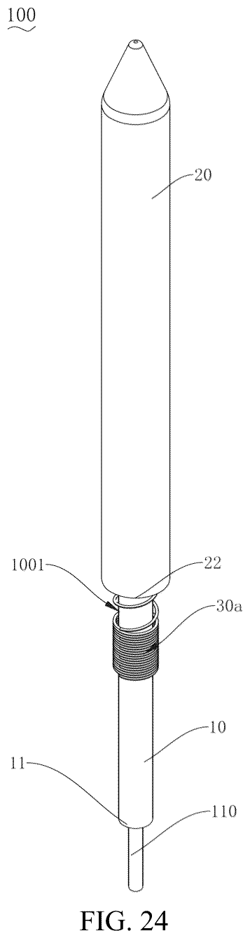

Refer to FIG. 24. In some embodiments, one end, fixed between the first end surface 11 and the second end surface 12 on the outer circumference of the inner tube 10, of the helical coil 30a may be exposed outside the outer tube 20.

In an aspect, the conductive wire 330 forms a mesh, and openings of the mesh form the hollowed-out portion 35.

In this way, the mesh formed by the conductive wire 330 can maintain a stable structure. In addition, the hollowed-out area of the hollowed-out portion 35 is large, which can effectively lower the heat capacity.

Specifically, the conductive member 30 may be a mesh tube formed by winding a plurality of conductive wires 330 in an interlaced manner. The mesh tube may be sleeved on the inner tube 10 and is in a close fit with the tube body of the inner tube 10. Alternatively, the conductive wires 330 may be arranged in an interlaced manner to form a mesh and coated onto the outer wall of the inner tube 10.

In an aspect, a wire material forming the helical coil 30a or the mesh tube is a circular wire, a flat-ribbon wire, or the like. The thickness of the cross-section of the wire material of the conductive member 30 ranges from 0.05 mm to 0.2 mm. Further, the thickness of the cross-section of the wire material of the conductive member 30 preferably ranges from 0.05 mm to 0.1 mm. For example, the thickness of the cross-section of the wire material of the conductive member 30 may be 0.05 mm, 0.06 mm, 0.07 mm, or 0.1 mm.

In some embodiments, the conductive member 30 is a coating applied to the outer wall of the inner tube 10. The conductive member 30 is coated onto the outer wall 10 of the inner tube, may form a path in a straight-strip shape, a cylindrical shape, a curved shape, or another shape, and conducts electricity along the corresponding path.

In an aspect, the first end portion 31 and the portion of the first electrode 110 exposed from the inner tube 10 are spaced apart in the axial direction of the inner tube 10.

In this way, the first end portion 31 may utilize space of the heating assembly 100 in the axial direction of the inner tube 10, so that the spacing between the first end portion 31 and the position where the first electrode 110 is exposed from the inner tube 10 is properly set. Consequently, the probability of discharge between the first end portion 31 and the first electrode 110 is reduced, and the reliability of normal operation of the heating assembly 100 is enhanced.

As described above, with reference to FIG. 12, the position where the first electrode 110 is exposed from the inner tube 10 is denoted as P. A position, closest to the point P in the axial direction of the inner tube 10, on the portion of the first end portion 31 extending out of the outer tube 20 is denoted as Q. The conductive member 30 may be bent at the position Q on the first end portion 31, continues to extend in the radial direction of the inner tube or a direction substantially the same as the radial direction of the inner tube, away from the first electrode 110, and is connected to the power supply 200.

The first end portion 31 is connected to the second end portion 32. The second electrode 120 is electrically connected to the second end portion 32 to form a conductive path with the conductive member 30 and to serve as a pole for conducting high-voltage electricity. A predetermined distance is maintained between P and Q, which are insulated through the inner tube 10. This avoids discharge or even discharge breakdown between P and Q in a case that the conductive member 30 and the first electrode 110 serve as two poles for conducting the high-voltage electricity, thereby ensuring the discharge reliability of the discharge region 130.

The inner tube 10 may be made of a high dielectric strength material. For example, the inner tube 10 is made of at least one material of quartz and ceramic.

This type of material is also capable of transmitting infrared radiation. The inner tube 10 has high dielectric strength, which may lower the probability of plasma arc breakdown through the inner tube 10. In some embodiments, the wall thickness of the inner tube 10 may range from 0.3 mm to 1.0 mm. For example, the wall thickness of the inner tube 10 may range from 0.3 mm to 1.0 mm, from 0.4 mm to 0.8 mm, from 0.5 mm to 0.7 mm, or from 0.55 mm to 0.6 mm. For another example, the wall thickness of the inner tube 10 may be 0.3 mm, 0.5 mm, 0.6 mm, 0.8 mm, or 1.0 mm. In this way, the inner tube 10 can have certain strength requirements, thereby avoiding stress-induced fracture and arc breakdown. Furthermore, this can lower the heat capacity and facilitate miniaturization of the heating assembly 100.

In some embodiments, proper heat capacity not only can enhance the heating efficiency during heating, but also can maintain a proper cooling rate during intervals between puffs, thereby avoiding excessive heating of the aerosol generating substrate 300.

Refer to FIG. 12 and FIG. 13. In an aspect, the inner tube 10 includes a first end surface 11 and a second end surface 12 opposite to the first end surface 11. The first electrode 110 is exposed from the first end surface 11 of the inner tube 10, and the first end portion 31 is at least partially located between the first end surface 11 and the second end surface 12.

In this way, by properly arranging the inner tube 10, the first electrode 110, and the conductive member 30, the inner tube 10 can isolate and protect the conductive member 30 and the first electrode 110, thereby reducing the likelihood of discharge breakdown between the first end portion 31 and the first end surface 11.

Specifically, the first end surface 11 and the second end surface 12 may be annular. The central axis 1011 of the inner tube 10 passes through the center of each of the first end surface 11 and the second end surface 12. The second electrode 120 may be disposed in the center of the second end surface 12. The conductive end 112 may encircle the center of the second end surface 12 to form the second end portion 32, and the second end portion 32 is electrically connected to the second electrode 120. It should be noted that the second end portion 32 of the conductive member 30 may be connected to the second electrode 120 in a plurality of manners. The encircling manner facilitates assembly and enhances connection reliability. It may be understood that the connection may alternatively be implemented in a manner such as crimping or welding.

The first electrode 110 may be inserted into the inner tube 10 from the center of the first end surface 11. The end, inserted into the inner tube 10, of the first electrode 110 faces the second electrode 120, and is spaced a predetermined distance from the first end surface 11. Alternatively, the end, inserted into the inner tube 10, of the first electrode 110 may be spaced the same distance from the first end portion 31 in the axial direction of the inner tube 10.

The inner tube 10 encloses at least a portion of the first electrode 110, and the conductive member 30 is attached to the outer wall of the inner tube 10, so that the inner tube 10 can provide insulation protection between the first electrode 110 and the conductive member 30. A predetermined distance is maintained between the end, exposing the inner tube 10 at the first end surface 11, of the first electrode 110 and the first end portion 31 in the axial direction of the inner tube 10, and the inner tube 10 covers a portion of a region between the partial first electrode 110 and the first end portion 31.

The shape of the cross-section of the inner tube 10 includes, but is not limited to, a circle, a square, an ellipse, and the like, and may further be matched with the shape of the cross-section of the first electrode 110.

Refer to FIG. 12 and FIG. 13 again. In an aspect, the entire first electrode 110 is in a cylindrical shape. The first electrode 110 may be in a hollow cylinder shape, or may be in a solid cylinder shape. The shape of the cross-section of the first electrode 110 includes, but is not limited to, a circle, an ellipse, a square, a polygon, and the like.

For example, the entire first electrode 110 is in a solid cylinder shape and is inserted into the inner tube 10 in a hollow cylinder shape, which facilitates miniaturization of the structural volume of a heating assembly. The first electrode 110 is inserted into the inner tube 10 and is coaxial with the inner tube 10.

In an aspect, the first electrode 110 includes a discharge end 111 and a conductive end 112 connected to the discharge end 111. The discharge end 111 is located in the inner tube 10, and the conductive end 112 extends out of the inner tube 10 from the first end surface 11. Therefore, it may be understood that in this embodiment, the foregoing position where the first electrode 110 is exposed from the inner tube 10 may be a position where the conductive end 112 is exposed from the inner tube 10.

Specifically, the discharge end 111 may be vertically inserted into the hollow space of the inner tube 10 and is opposite to the second electrode 120. The conductive end 112 extends out of the inner tube 10, is connected to the power supply 200, and conducts high-voltage electricity to generate plasma between the discharge end 111 and the second electrode 120.

In the orientation shown in FIG. 12, in the axial direction of the inner tube 10, a direction pointing from the second end surface 12 to the first end surface 11 may be an up-down direction.

In the heating assembly 100, the second electrode 120, the second end portion 32 of the conductive member 30, the discharge end 111 of the first electrode 110, the first end portion 31 of the conductive member 30, and the conductive end 112 of the first electrode 110 are sequentially arranged from top to bottom in the axial direction of the inner tube 10. The first end surface 11 is located below the first end portion 31, and the second end surface 12 is in a close fit with one side surface of the second electrode 120.

In some embodiments, the first electrode 110 is in a cylindrical shape, and the diameter of the first electrode 110 ranges from 0.4 mm to 1.0 mm. It should be noted that the shape of the cross-section of the first electrode 110 herein is not limited to a circle, and may be a square, a polygon, an ellipse, or the like. The diameter of the first electrode 110 is the diameter of a circumscribed circle of the cross-section of the first electrode 110.

This facilitates miniaturization of the heating assembly 100 and improves the burn resistance lifespan of the first electrode 110.

For example, the first electrode 110 may be a metal wire having a diameter of not less than 0.4 mm and not greater than 1.0 mm. The diameter of the first electrode 110 may be slightly smaller than the inner diameter of the inner tube 10. For example, the diameter of the first electrode 110 may range from 0.4 mm to 1.0 mm, from 0.5 mm to 0.9 mm, from 0.6 mm to 0.7 mm, or from 0.75 mm to 0.8 mm. For another example, the diameter of the first electrode 110 may be 0.4 mm, 0.5 mm, 0.6 mm, 0.7 mm, 0.8 mm, 0.9 mm, or 1.0 mm.

It may be understood that, discharge occurs between the end, inserted into the inner tube 10, of the first electrode 110 and the second electrode 120 to generate the plasma arc. Therefore, the first electrode and the second electrode need to withstand high-temperature burning of the plasma arc. When the diameter of the first electrode 110 is relatively large, a greater amount of heat is required to cause burning. Appropriately increasing the diameter of the first electrode 110 can enhance the burn resistance lifespan of the first electrode. In addition, the diameter of the first electrode 110 is limited by the inner diameter of the inner tube 10. For product miniaturization needs, the diameter of the first electrode 110 does not exceed 1.0 mm.

In some embodiments, the first electrode 110 is made of a heat-resistant conductive material. Specifically, the first electrode 110 is made of at least one material of nickel-based alloys, iron-based alloys, copper-based alloys, zirconium, hafnium, and tungsten. Use of the foregoing heat-resistant conductive material enables the first electrode 110 to have better durability at the high temperatures generated by the plasma arc. A material of the first electrode 110 and a material of the second electrode 120 may be the same or may be different.

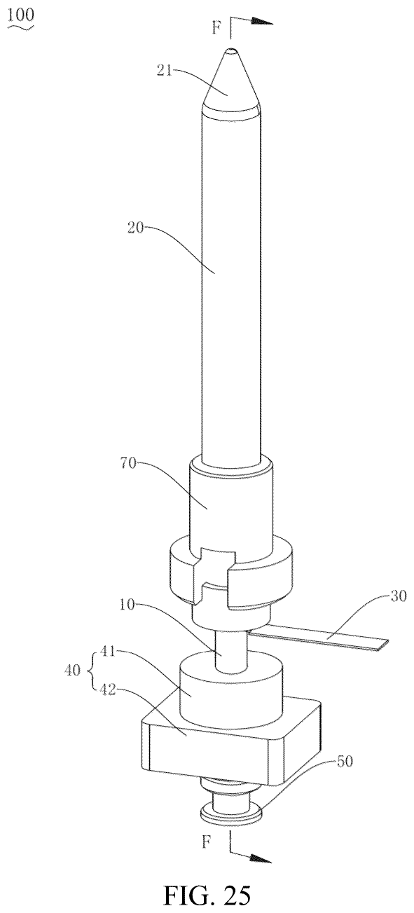

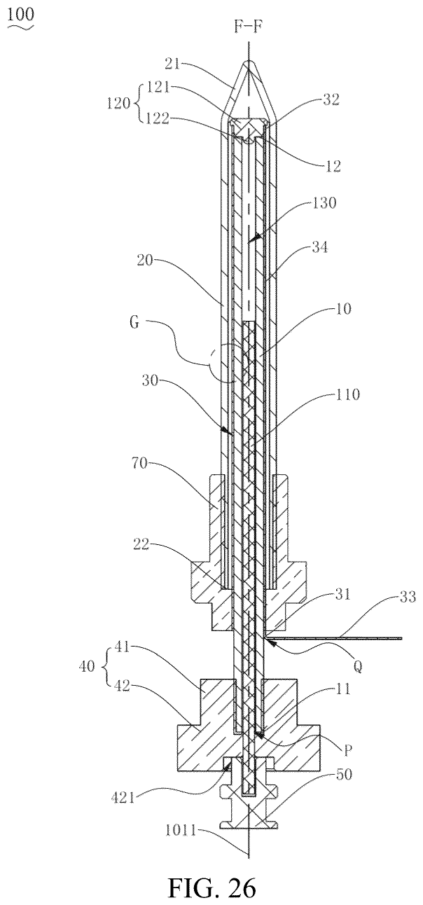

Refer to FIG. 25 and FIG. 26. In an aspect, the heating assembly 100 includes an insulating member 40 connected to the inner tube 10. At least a portion of the insulating member 40 is located between the first end portion 31 and the first end surface 11.

In an aspect, the insulating member 40 is sleeved on the inner tube 10 and is not in direct contact with the inner tube 10. At least a portion of the insulating member 40 is located between the first end portion 31 and the first end surface 11.

In this way, the insulating member 40 enhances the dielectric strength between the first end portion 31 and the first end surface 11, thereby further reducing the likelihood of discharge breakdown between the first end portion 31 and the first end surface 11 and improving the insulation performance and heating reliability of the heating assembly 100.

Specifically, the insulating member 40 may be fixedly connected to the end of the inner tube 10 away from the second electrode 120. The insulating member 40 may be sleeved on the inner tube 10 to isolate the first end surface 11 from the first end portion 31. The insulating member 40 may be a sleeve made of a soft insulating material, such as a sleeve made of rubber. The insulating member 40 may be a rubber sleeve that is in an interference fit with the inner tube 10. Alternatively, the insulating member 40 may be an encapsulating adhesive, encapsulating glass frit, or the like disposed at the end of the inner tube 10 close to the first end surface 11.

In an aspect, the end portion, having the first end surface 11, of the inner tube 10 is inserted into the insulating member 40, and the first electrode 110 passes through the insulating member 40.

In this way, at the first end surface 11, the first electrode 110, the inner tube 10, and the insulating member 40 are nested in sequence, to form a compact structure, which facilitates assembly and production. In addition, the portion of the first electrode 110 located at the first end surface 11 is encapsulated by the insulating member 40, thereby reducing the likelihood of discharge between the point P of the first electrode 110 and the point Q of the conductive member 30.

Specifically, the insulating member 40 may be in a hollow tube shape, and the tube wall of the insulating member 40 is thicker than the wall of the inner tube 10. The first electrode 110 may pass through the first end surface 11 of the inner tube 10 and the insulating member 40 in sequence. The end portion, having the first end surface 11, of the inner tube 10 encloses the first electrode 110, and is inserted into the insulating member 40 together with the first electrode 110. The first electrode 110 may extend from the first end surface 11, pass through the insulating member 40 in the axial direction of the inner tube 10, and exit from the side of the insulating member 40 facing away from the first end surface 11 to the outside of the insulating member 40.

Refer to FIG. 25 and FIG. 26. In an aspect, the insulating member 40 includes a first insulating portion 41 and a second insulating portion 42 connected to the first insulating portion 41. The cross-sectional area of the first insulating portion 41 is smaller than the cross-sectional area of the second insulating portion 42. The end portion, having the first end surface 11, of the inner tube 10 is inserted into the first insulating portion 41, and the first electrode 110 passes through the second insulating portion 42.

In this way, the insulating member 40 may form different degrees of coverage and electrical isolation between the inner tube 10 and the first electrode 110, thereby improving the structural stability and strengthening insulation protection for the first electrode 110 through the second insulating portion 42.

Refer to FIG. 26. For example, the first insulating portion 41 is connected to the second insulating portion 42. The first insulating portion 41 is in a hollow cylinder shape, and the second insulating portion 42 is in a cubic shape and has a through hole 421 in the center. The through hole 421 in the center of the second insulating portion 42 and the hollow portion of the first insulating portion 41 may be continuous.

Refer to FIG. 26. The inner tube 10 enclosing the first electrode 110 is inserted into the first insulating portion 41. The first electrode 110 extends out of the inner tube 10 from the first end surface 11 in the first insulating portion 41 and is inserted into the through hole 421 of the second insulating portion 42.

Refer to FIG. 25 to FIG. 26 again. In an aspect, the insulating member 40 covers the portion of the first electrode 110 located at the first end surface 11.

In this way, the insulating member 40 reduces the probability of discharge breakdown at the first end surface 11 of the first electrode 110, and can further shorten a distance between the end, extending out of the inner tube 10, of the first electrode 110 and the first end portion 31, which facilitates miniaturization of the heating assembly 100.

In the related technology, the first electrode and the conductive member are respectively connected to two poles of the external power supply, and a large distance needs to be maintained between the portion of the first electrode extending out of the inner tube and the first end portion of the conductive member, to avoid discharge breakdown between the first electrode and the first end portion and prevent damage to the heating assembly. The insulating member 40 provided in the implementations of this disclosure covers the portion of the first electrode 110 extending out of the inner tube 10, resulting in a small distance between the end of the first electrode 110 extending out of the inner tube 10 and the first end portion 31.

Specifically, the second insulating portion 42 covers the portion of the first electrode 110 extending out of the inner tube 10 from the first end surface 11. The first electrode 110 is enclosed by the inner tube 10 and the first insulating portion 41 in sequence in the first insulating portion 41, and the portion of the first electrode 110 exposed outside the inner tube 10 is enclosed only by the second insulating portion 42.

It may be understood that the cross-sectional area of the first insulating portion 41 is smaller than the cross-sectional area of the second insulating portion 42, and the thickness of the second insulating portion 42 is greater than the thickness of the first insulating portion 41, so that the dielectric strength of the second insulating portion 42 is higher. The second insulating portion 42 has the larger cross-sectional area, which enhances the insulation protection for the portion of the first electrode 110 exposed from the inner tube 10.

In some embodiments, the insulating member 40 abuts against the first end surface 11, to enhance structural compactness and improve insulation performance.

Refer to FIG. 25 and FIG. 26 again. In an aspect, the heating assembly 100 includes a connector 50 which is connected to the end of the first electrode 110 away from the second electrode 120. The connector 50 is configured to be electrically connected to the power supply 200, the connector 50 is located on the side of the insulating member 40 facing away from the first end portion 31, and the insulating member 40 covers the connector 50 in the axial direction of the inner tube 10.

In this way, by connecting the first electrode 110 to the power supply 200 through the connector 50, the distance required to maintain insulation between the first electrode 110 and the first end portion 31 can be further shortened. Therefore, the heating assembly 100 has a more compact structure.

Specifically, the connector 50 is electrically connected to the end of the first electrode 110 away from the second electrode 120. The connector 50 may be in a disk shape and covers the portion of the first electrode 110 protruding from the second insulating portion 42. The end of the connector 50 connected to the first electrode 110 may extend into the through hole 421 of the second insulating portion 42. The insulating member 40 is at least partially located between the connector 50 and the conductive member 30. The second insulating portion 42 may cover the side of the connector 50 connected to the first electrode 110.

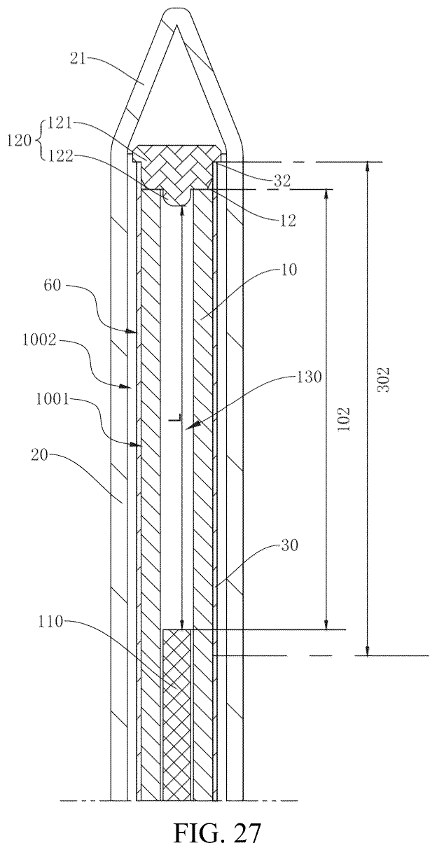

Refer to FIG. 26 and FIG. 27. In an aspect, the second electrode 120 abuts against the second end surface 12.

In this way, the second electrode 120 may be mounted at the end of the inner tube 10 that has the second end surface 12, and the second end surface 12 fixes and limits the second electrode 120.

Specifically, the second electrode 120 may cover the entire second end surface 12 to close the end of the inner tube 10 that has the second end surface 12. The side of the second electrode 120 facing the first electrode 110 is in a close fit with the second end surface 12. The side of the second electrode 120 facing away from the second end surface 12 faces the closed end of the outer tube 20.

In some embodiments, the second electrode 120 is made of a heat-resistant conductive material. Use of the heat-resistant conductive material can improve the burn resistance lifespan of the second electrode 120, thereby improving the discharge reliability of the heating assembly 100. For example, the second electrode 120 is made of at least one of nickel-based alloys, iron-based alloys, copper-based alloys, zirconium, hafnium, and tungsten.

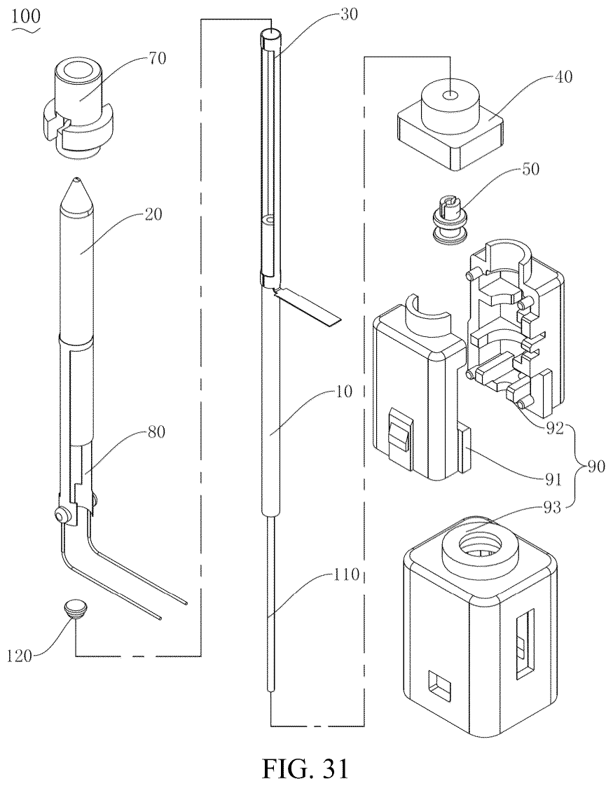

Refer to FIG. 27 and FIG. 31. In an aspect, the second electrode 120 includes a mounting portion 121 and a protrusion 122 formed on the mounting portion 121. The protrusion 122 extends into the inner tube 10 and directly faces the first electrode 110.

In this way, the protrusion 122 can guide discharge between the first electrode 110 and the second electrode 120 within the inner tube 10, thereby facilitating generation of the plasma arc.

Specifically, the mounting portion 121 may be in a disk shape, and the diameter of the mounting portion 121 may be slightly greater than the outer diameter of the inner tube 10. The mounting portion 121 abuts against the second end surface 12, and the second end portion 32 of the conductive member 30 is wound around the second electrode 120, so that the second electrode 120 is fixedly disposed at the end portion of the inner tube 10 that has the second end surface 12.

The protrusion 122 may be spherical or hemispherical and is formed on the side of the mounting portion 121 abutting against the second end surface 12. The width of the protrusion 122 in the axial direction of the inner tube 10 is smaller than the inner diameter of the inner tube 10, and the width gradually decreases as the protrusion extends toward the second electrode 120 in the axial direction of the inner tube 10.

It may be understood that the protrusion 122 has a relatively large curvature radius on the outer circumference, which allows charges in the conductive medium to concentrate at the position with the large curvature radius, thereby generating a high electric field intensity that is conductive to the generation of plasma. The width of the protrusion 122 varies gradually in the axial direction of the inner tube 10, to prevent the protrusion 122 from becoming excessively sharp, which may cause charge concentration and may result in ablation.

Refer to FIG. 15 and FIG. 26. In an aspect, the center of the protrusion 122 is located on the central axis 1011 of the inner tube 10.

In this way, the protrusion 122 can guide the arc to discharge at the central point of the first electrode 110, thereby improving circumferential uniformity of the discharge temperature.

As described above, the first electrode 110 is coaxial with the inner tube 10. The discharge region 130 is a region where the plasma arc is generated by the discharge between the second electrode 120 and the first electrode 110. The second electrode 120 guides discharge through the protrusion 122 facing the first electrode 110. The center of the protrusion 122 is located on the central axis 1011 of the inner tube 10, and the center of the first electrode 110 is also located on the central axis 1011 of the inner tube 10. Therefore, the probability that the center of the discharge region 130 is located on the central axis 1011 of the inner tube 10 is higher.

In some embodiments, the end surface of the end, extending into the inner tube 10, of the first electrode 110 slightly protrudes, to form a blunt arc shape with a smooth surface. The apex of the protrusion on the end surface of the first electrode 110 may be located on the central axis 1011 of the inner tube 10 and is opposite to the protrusion 122 of the second electrode 120.

In some embodiments, the end, extending into the inner tube 10, of the first electrode 110 has a flat end surface, and the center of the end surface is located on the central axis 1011 of the inner tube 10 and directly faces the apex of the protrusion 122.

Refer to FIG. 26 and FIG. 27 again. In some embodiments, the outer tube 20 includes a tapered end portion 21. The second electrode 120 is disposed at one end of the inner tube 10 and abuts against the inner wall surface of the tapered end portion 21.

The end of the outer tube 20 that has the tapered end portion 21 is inserted into the aerosol generating substrate 300. A protrusion 122 is formed in the center of the second electrode 120, the protrusion 122 extends into the inner tube 10, and the center of the protrusion 122 is located on the central axis 1011 of the inner tube 10. The outer tube 20 is approximately coaxial with the inner tube 10. The side of the mounting portion 121 facing away from the second end surface 12 abuts against the inner wall surface of the tapered end portion 21.

In this way, the second electrode 120 abuts against the outer tube 20 and the inner tube 10, which can achieve automatic centering and alignment, thereby making assembly convenient and facilitating the uniform transfer of heat to the circumference of the outer tube 20.

Refer to FIG. 26 again. A position where the first electrode 110 is exposed from the inner tube 10 may be denoted as P, and a position of the first end portion 31 that is closest to the point P may be denoted as Q.

In an aspect, in the axial direction of the inner tube 10, a distance between the first end portion 31 and the position where the first electrode 110 is exposed from the inner tube 10 is greater than or equal to 2 mm.

This can reduce the risk of arc breakdown at the first end portion 31. In addition, this can shorten the axial distance between the position where the first electrode 110 extends out of the inner tube 10 and the first end portion 31, thereby reducing the length of the heating assembly 100 in the axial direction of the inner tube 10 and lowering costs.

For example, a connecting line segment between the point P and the point Q is in the same direction as the central axis 1011 of the inner tube 10. It may be understood that the length of the connecting line segment between the point P and the point Q is equal to the minimum value of the distance between the first end portion 31 and the position where the first electrode 110 is exposed from the inner tube 10. The length of the connecting line segment between the point P and the point Q is not less than 2 mm. The length of the connecting line segment between the point P and the point Q may be 2.1 mm, 2.3 mm, 2.5 mm, 2.6 mm, 3 mm, or 4 mm. Distances between other positions on the conductive member 30 and the portion of the first electrode 110 exposed from the inner tube are greater than the length of the connecting line segment between the point P and the point Q.

It should be noted that the connecting line segment between the point P and the point Q being in the same direction as the central axis 1011 of the inner tube 10 is not intended to limit the connecting line segment between the point P and the point Q being parallel to the central axis of the inner tube 10. The connecting line segment between the point P and the point Q may be approximately parallel to the central axis of the inner tube, or an included angle between the connecting line segment between the point P and the point Q and the central axis 1011 of the inner tube 10 is less than or equal to 60°, or less than or equal to 30°.

In an aspect, the minimum distance between the conductive member 30 and the position where the first electrode 110 is exposed from the inner tube 10 is greater than or equal to 2 mm. As described above, maintaining the distance between the conductive member 30 and the position where the first electrode 110 is exposed from the inner tube 10 can prevent breakdown from occurring outside the discharge region 130, thereby avoiding failure of the heating assembly 100.

Specifically, the second end portion 32 of the conductive member 30 is fixed to the first end surface 11 of the inner tube 10, and extends on the outer wall of the inner tube 10 from the second end surface 12 to the first end surface 11. The conductive member 30 is close to the second end surface 12, and the end portion closest to the position where the first electrode 110 is exposed from the inner tube 10 is the first end portion 31. In other words, a distance between the position where the first electrode 110 is exposed from the inner tube 10 and portions of the conductive member 30 and the connecting wire 33 other than the first end portion 31 is greater than a distance between the first end portion 31 and the position where the first electrode 110 is exposed from the inner tube 10.

Further, the distance between the first end portion 31 and the position where the first electrode 110 is exposed from the inner tube 10 is set to have a critical value of 2 mm. The distance between the first end portion 31 and the position where the first electrode 110 is exposed from the inner tube 10 exceeds the critical value of 2 mm. When high voltage is applied between the first electrode 110 and the conductive member 30, breakdown tends to occur in the region between the first end portion 31 and the portion of the first electrode 110 exposed outside the inner tube 10.

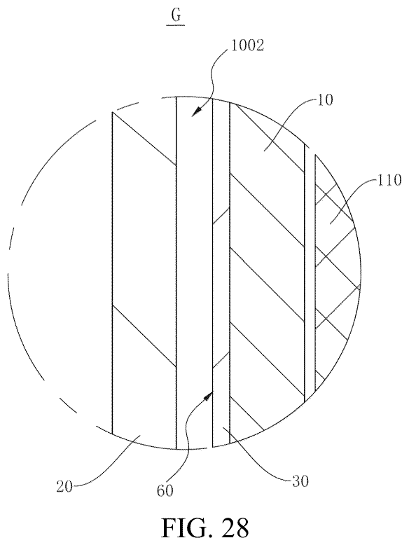

Refer to FIG. 27 and FIG. 28. In an aspect, the heating assembly 100 includes an infrared radiation film 60. The infrared radiation film 60 is disposed on the inner tube 10, the outer tube 20, and/or the conductive member 30.

In this way, the capability of the heating assembly 100 to heat through infrared radiation may be enhanced, thereby further improving the utilization of the heat generated by the plasma arc.

Specifically, the infrared radiation film 60 may be a coating adhered to the inner wall or the outer wall surface of the inner tube 10, the outer tube 20, and/or the conductive member 30.

The infrared radiation film 60 may be made of a material that can specifically absorb infrared radiation, such as a metal oxide or silicone.

For example, the infrared radiation film 60 may be a film made of one or more of the following materials: iron-manganese-copper oxide, CrC, TiCN, diamond-like carbon (DLC), black silicone (HBQ), cordierite, spinel-type transition metal oxides, rare-earth oxides, ion-co-doped perovskites, silicon carbide, zircon, boron nitride, and the like. For example, the infrared radiation film 60 is applied to the outer wall surfaces of the outer tube 20 and the conductive member 30, as well as the surface, uncovered by the conductive member 30, of the outer wall of the inner tube 10.

Refer to FIG. 27 and FIG. 28 again. In an aspect, a heat insulating gap 1002 is formed between each of the inner tube 10 and the conductive member 30 and the inner wall surface of the outer tube 20.

In this way, by arranging the heat insulating gaps 1002, a temperature difference between the outer tube 20 and the center of the discharge region 130 can be increased, to prevent prolonged overheating of the outer tube 20, thereby increasing the radiation temperature in the center of the discharge region 130, and increasing energy of infrared radiation.

Specifically, the high temperature of the plasma arc in the center of the discharge region 130 may exceed 2000° C., and the stable temperature is 1000° C. to 1600° C. The heat from the discharge region 130 is radiated in the form of infrared radiation through the inner tube 10 and the outer tube 20 to the aerosol generating substrate 300.

In some embodiments, a temperature measuring assembly 80 may also be arranged in a heat insulating gap 1002 between the inner tube 10 and the outer tube 20. The temperature measuring assembly 80 may include a thermocouple or a temperature measuring probe, which can be located in a region below the discharge region 130.

The outer tube 20, at the temperature of approximately 350° C., may achieve a good heating effect on the aerosol generating substrate 300. The heat insulating gap 1002 is disposed between the outer tube 20 and each of the inner tube 10 and the conductive member 30, to isolate the outer tube 20 from the discharge region 130 at a distance. This prevents heat from concentrating in the outer tube 20, thereby avoiding prolonged overheating of the outer tube 20. By isolating the outer tube 20 from the inner tube 10 and the conductive member 30 through the heat insulating gaps 1002, the temperature difference between the outer tube 20 and the discharge region 130 is increased. Under a condition that the temperature of the outer tube 20 does not exceed 350° C., the temperature of the discharge region 130 can be relatively increased, which can greatly shorten pre-heating duration. The energy of infrared radiation is proportional to the fourth power of the temperature. Therefore, a higher temperature in the center of the discharge region 130 results in greater energy being radiated toward the aerosol generating substrate 300.

In some embodiments, the width of the heat insulating gap 1002 ranges from 0.05 mm to 0.3 mm.

This can avoid prolonged overheating of the outer tube 20, and maintain a compact and miniaturized structure of the heating assembly 100.

For example, the width of the heat insulating gap 1002 ranges from 0.05 mm to 0.3 mm, from 0.06 mm to 0.15 mm, from 0.15 mm to 0.3 mm, from 0.07 mm to 0.25 mm, or from 0.1 mm to 0.2 mm. For example, the width of the heat insulating gap 1002 is 0.05 mm, 0.06 mm, 0.08 mm, 0.12 mm, 0.16 mm, 0.17 mm, 0.2 mm, 0.25 mm, 0.28 mm, or 0.3 mm. Specifically, the heat insulating gaps 1002 between the inner tube 10 and the outer tube 20 may be unequal. The outer wall of the inner tube 10 is partially covered by the conductive member 30, and the heat insulating gap 1002 at the portion of the inner tube 10 covered by the conductive member 30 is smaller than that at the portion of the inner tube 10 facing the outer tube 20.

The heat insulating gap 1002 between the inner tube 10 and the outer tube 20 has a uniform width, which can improve the coaxiality of the outer tube 20 relative to the inner tube 10 and enhance the circumferential temperature uniformity of the discharge region 130.

Refer to FIG. 25 and FIG. 26. In an aspect, the heating assembly 100 includes an elastic member 70. The elastic member 70 is sleeved on the end portion of the outer tube 20 far away from the second electrode 120, and the inner tube 10 passes through the elastic member 70.

In this way, the elastic member 70 may fix and limit the inner tube 10, the conductive member 30, and the outer tube 20, thereby improving the mechanical impact resistance of the heating assembly 100. In addition, it ensures that the discharge heating center inside the inner tube 10 maintains a high degree of coaxiality with the outer tube 20, which contributes to improving the uniformity of the temperature field on the circumference of the needle body. In addition, the elastic member 70 can seal the open end 22, thereby mitigating the escape of discharge odors.

In some embodiments, the elastic member 70 has elasticity. The elastic member 70 encloses the outer tube 20, the conductive member 30, and the inner tube 10, and performs interference fit compression assembly on the outer tube 20, the conductive member 30, and the inner tube 10. The elastic member 70 covers the open end 22 of the outer tube 20 and the inner tube 10 and the first end portion 31 that extend out from the open end 22. The elastic member 70 maintains a particular distance from the arc. In an aspect, the upper end of the elastic member 70 is at a distance of 4 mm to 10 mm from the lower end of the discharge region 130, to prevent the elastic member 70 from being heated and fused. For example, a distance between the upper end of the elastic member 70 and the lower end of the discharge region 130 is 5 mm, 6 mm, 7 mm, 8 mm, 9 mm, or 10 mm.

The elastic member 70 may be made of a dense elastic material for support. For example, the elastic member 70 may be a sleeve made of rubber.

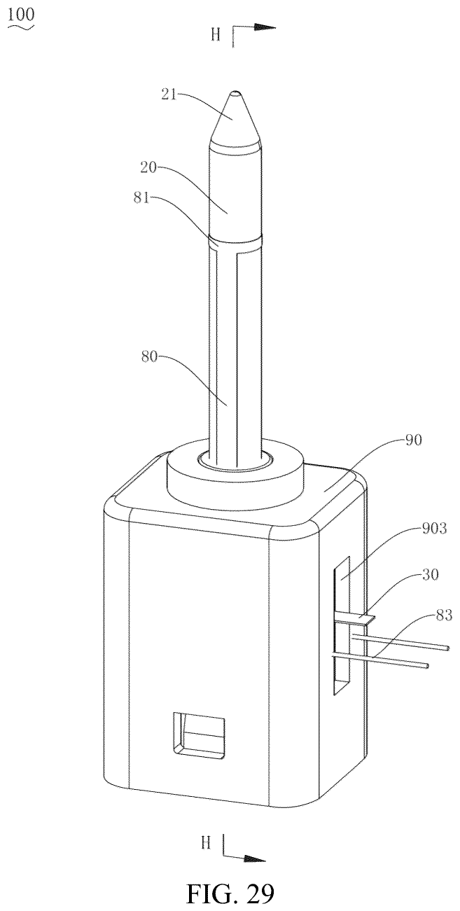

Refer to FIG. 29. In some embodiment, the heating assembly 100 may include a base 90. The inner tube 10 is mounted on the base 90.

In this way, the base 90 can fix and mount the tubular element in the heating assembly 100, thereby improving structural stability.

Specifically, the portion of the outer tube 20 exposed from the base 90 is inserted into the aerosol generating substrate 300. The height of the outer tube 20 exposed from the base 90 ranges from 14 mm to 20 mm. For example, the height of the outer tube 20 exposed from the base 90 ranges from 14 mm to 18 mm, from 15 mm to 19 mm, or from 16 mm to 17 mm. For another example, the height of the outer tube 20 exposed from the base 90 is 14 mm, 14.5 mm, 15 mm, 16 mm, 18 mm, or 20 mm.

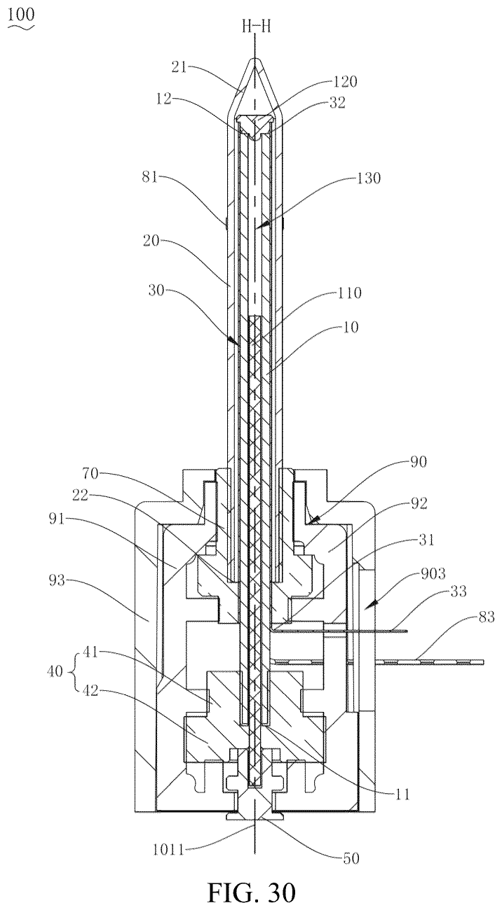

Refer to FIG. 30 and FIG. 31. In an embodiment, the base 90 may include a first bracket 91, a second bracket 92, and a housing 93. The first bracket 91 and the second bracket 92 are interlocked, and the housing 93 covers the first bracket 91 and the second bracket 92. The first bracket 91 and the second bracket 92 fit with the outer diameter of the insulating member 40, to fixedly mount the insulating member 40 between the first bracket 91 and the second bracket 92, so that the portion, exposed outside the inner tube 10, of the first electrode 110 that is enclosed by the insulating member 40 and the end of the inner tube 10 that includes the first end surface 11 are mounted and fixed in the base 90. The first bracket 91 and the second bracket 92 fit with the outer diameter of the elastic member 70, so that the end of the outer tube 20 close to the first end surface 11 and the end of the conductive member 30 that includes the first end portion 31 are mounted and fixed in the base 90. The housing 93 is provided with a wire outlet hole 903. With reference to FIG. 1, the connecting wire 33 may extend out of the base 90 from the wire outlet hole 903 to connect to the power supply 200, and the temperature measuring lead 83 may be connected to the control center 400 through the wire outlet hole 903.

The first bracket 91 and the second bracket 92 may interlock with each other up and down. Refer to FIG. 1. An aerosol generating device 1000 provided in examples of this disclosure includes the heating assembly 100 according to any one of the foregoing examples. In an embodiment, the aerosol generating device 1000 may include a battery 210 and a transformer 220. The battery 210 and the transformer 220 may together form a power supply 200 of the aerosol generating device 1000. With reference to FIG. 30, the first electrode 110 and the second electrode 120 are respectively connected to two output terminals of the transformer 220, conduct high-voltage alternating current, and generate a high-intensity electric field within the inner tube 10, thereby generating plasma and producing high temperature and heat. The heating assembly 100 is connected to a cover 500, the outer tube 20 is inserted into the aerosol generating substrate 300, and the heat is transferred to the aerosol generating substrate 300 through the inner tube 10 and the outer tube 20. The aerosol generating substrate 300 absorbs the heat and is atomized to generate an aerosol.

In the description of this specification, the descriptions made with reference to the terms “one implementation”, “an aspect”, “an exemplar implementation”, “an example”, “a specific example”, or “some examples” mean that specific features, structures, materials, or characteristics described with reference to the examples are included in this disclosure. In this specification, exemplary descriptions of the foregoing terms do not necessarily refer to the same implementation or example. In addition, the described specific features, structures, materials, or characteristics may be combined in a proper manner in any one or more of the implementations or examples.

Although the examples of this disclosure have been shown and described, those of ordinary skill in the art may understand that various changes, modifications, replacements, and variations may be made to these examples without departing from the principle and spirit of this disclosure. The scope of this disclosure is subject to the claims and equivalents thereof.

What is claimed is:

1. A heating assembly comprising
an outer tube;
a first electrode and a second electrode, both the first electrode and the second electrode being at least partially disposed inside the outer tube, the first electrode and the second electrode are disposed opposite to each other at an interval;
a plasma being generated between the first electrode and the second electrode when the first electrode and the second electrode are energized; and
a temperature measuring assembly being configured to detect the temperature of the outer tube.

2. The heating assembly of claim 1, the temperature measuring assembly further comprising:
a temperature sensing portion and a conductive portion connected to the temperature sensing portion, wherein the temperature sensing portion is disposed on the outer tube.

3. The heating assembly of claim 2, wherein the temperature sensing portion is disposed on the outer wall or the inner wall of the outer tube.

4. The heating assembly of claim 3, wherein the temperature sensing portion comprises a temperature sensing film attached to the outer tube.

5. The heating assembly of claim 4, wherein the temperature sensing film at least partially extends in a circumferential direction of the outer tube.

6. The heating assembly of claim 5, wherein the temperature sensing film is in a closed ring shape, a ring shape with an opening, or a U shape.

7. The heating assembly of claim 4, wherein a width of the temperature sensing film ranges from 0.5 mm to 1.2 mm in an axial direction of the outer tube.

8. The heating assembly of claim 2, wherein a resistance of the temperature sensing portion is greater than a resistance of the conductive portion.

9. The heating assembly of claim 2, wherein
the first electrode comprises a discharge end surface facing the second electrode,
the temperature sensing portion is disposed on a side of the discharge end surface far away from the second electrode.

10. The heating assembly of claim 9, wherein a distance between the temperature sensing portion and the discharge end surface ranges from 0 mm to 2 mm in an axial direction of the outer tube.

11. The heating assembly of claim 2, wherein a temperature coefficient of the temperature sensing film is greater than or equal to 300 ppm/° C.

12. The heating assembly of claim 2, further comprising:
a protective layer enclosing at least one of the temperature sensing portion and the conductive portion.

13. The heating assembly of claim 2, wherein the conductive portion further comprises two sub-conductive portions that are arranged at an interval in a circumferential direction of the outer tube.

14. The heating assembly of claim 1, further comprising:
an inner tube being at least partially disposed inside the outer tube, wherein the first electrode is at least partially disposed inside the inner tube, at least a portion of the second electrode is disposed at one end of the inner tube, and the first electrode and the second electrode are disposed opposite to each other at an interval.

15. The heating assembly of claim 2, wherein the temperature sensing portion comprises a temperature measuring probe or a thermocouple.

16. An aerosol generating device comprising:
power supply;
a heating assembly including
an outer tube,
a first electrode and a second electrode, both the first electrode and the second electrode being at least partially disposed inside the outer tube, the first electrode and the second electrode are disposed opposite to each other at an interval,
a plasma being generated between the first electrode and the second electrode when the first electrode and the second electrode are energized, and
a temperature measuring assembly being configured to detect the temperature of the outer tube; and
wherein the power supply is electrically connected to the heating assembly.

17. The aerosol generating device of claim 1, the temperature measuring assembly further comprising:
a temperature sensing portion and a conductive portion connected to the temperature sensing portion, wherein the temperature sensing portion is disposed on the outer tube.

18. The aerosol generating device of claim 2, wherein the temperature sensing portion is disposed on the outer wall or the inner wall of the outer tube.

19. The aerosol generating device of claim 3, wherein the temperature sensing portion comprises a temperature sensing film attached to the outer tube.

20. The aerosol generating device of claim 4, wherein the temperature sensing film at least partially extends in a circumferential direction of the outer tube.
